(19) United States
(12) Patent Application Publication
(10) Pub. No.: US 2020/0197903 A1
(43) Pub. Date: Jun. 25, 2020

(54) AN ADSORBENT

(71) Applicant: The University of Newcastle, Callaghan, NSW (AU)

(72) Inventor: Brett TURNER, Callaghan, NSW (AU)

(21) Appl. No.: 16/643,074

(22) PCT Filed: Aug. 28, 2018
(86) PCT No.: PCT/AU2018/050916

§ 371 Date: Feb. 28, 2020

(30) Foreign Application Priority Data
Aug. 28, 2017 (AU) 2017903465

(51) Int. Cl. B01J 20/24; B01J 20/04; B01J 20/10; B01J 20/16; B09C 1/00; C02F 1/28; B09B 3/00

(52) U.S. Cl. CPC B01J 20/24; B01J 20/043; B01J 20/103; B01J 20/165; C02F 2101/36; C02F 1/286; C02F 1/288; B09B 3/0083; B09C 1/002

(57) ABSTRACT

An adsorbent for perfluoroalkyl and polyfluoroalkyl substances, wherein the adsorbent comprises one or more proteins. The one or more proteins may be selected from plant proteins, albumins, globulins, edestin, glycinin and/or beta-conglycinin. Use of an adsorbent for treatment of a material contaminated with perfluoroalkyl and polyfluoroalkyl substances. There is also provided a process for the treatment of ground water contaminated with perfluoroalkyl and polyfluoroalkyl substances, wherein the contaminated ground water is pumped to the surface and directed to an adsorption step comprising the adsorbent.

### TECHNICAL FIELD

The present invention generally relates to adsorbents for the removal of perfluoroalkyl and polyfluoroalkyl substances from water.

### BACKGROUND

Perfluoroalkyl and polyfluoroalkyl substances (PFASs) have been widely used for various purposes, including for fire-fighting foams. Aqueous film-forming foams (AFFFa) containing PFASs have been demonstrated to be highly effective in fighting hydrocarbon fuel fires and as such, significant numbers of fire-fighting training facilities around the world have been identified as being contaminated by PFAS.

The entire family of PFASs may be broken down into four sub-classes, namely perfluoroalkyl sulfonic acids (PFSAs), perfluoalkyl carboxylic acids (PFCAs), perfluoroalkyl sulfonamides (FOSAs) and fluorotelomer sulfonic acids (FTSs).

PFASs are considered almost non-degradable in nature and therefore pose a significant challenge for remediation, with many conventional approaches to treatment of PFAS in water not being effective. The complex chemistry of PFAS make them highly soluble and therefore easily transported by groundwater and surface water. As the chemistry of PFAS substances changes with increasing carbon chain length, pH, salinity and other variables, PFAS contamination is considered extremely difficult and expensive to remediate. Furthermore, there currently exists no single method that that can adequate remediate contamination of the entire family of PFAS chemicals.

Removal of remediation of ground and surface water contaminated with PFASs typically involves an adsorption process, as PFASs are not effectively degraded using biological or chemical treatment options. Granulated activated carbon (GAC) has been shown to be an effective substrate adsorbent for long-chain PFASs. However, GAC is less effective for the treatment of more hydrophilic shorter chain PFASs, for example PFBS (butanoates; C4 lengths). Accordingly, use of GAC filters may be used in conjunction with other treatment methods such as reverse osmosis resin to broaden the number of PFASs removed during treatment. Combining GAC adsorption with reverse osmosis resin adds significantly to the complexity and costs of PFAS remediation. Additionally, such a process generates by-products of PFAS contaminated GAC, and PFAS contaminated hyper-saline liquor created during RO resin regeneration.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### BRIEF SUMMARY

The present invention seeks to provide an invention with improved features and properties.

According to one example aspect the present invention provides an adsorbent for perfluoroalkyl and polyfluoroalkyl substances, wherein the adsorbent comprises one or more plant proteins.

In an embodiment, the one or more proteins include albumins.

In an embodiment, the one or more proteins include globulins.

In an embodiment, the one or more proteins include edestin.

In an embodiment, the one or more proteins include glycinin.

In an embodiment, the one or more proteins include beta-conglycinin.

In an embodiment, the one or more proteins are structurally similar to albumins and/or globulins and/or edestin and/or glycinin and/or beta-conglycinin.

In an embodiment, the one or more proteins are derived from hemp seeds.

In an embodiment, the adsorbent comprises hemp seeds.

In an embodiment, the adsorbent comprises hemp protein isolate.

In an embodiment, the adsorbent comprises soy protein.

In an embodiment, the adsorbent further comprises calcite.

In an embodiment, the adsorbent further comprises an inert substance configured to increase the permeability of the adsorbent.

In an embodiment, the inert substance is glass beads.

In an embodiment, the inert substance is gravel.

According to one example aspect the present invention provides use of an adsorbent according to any one of the above aspects or embodiments for treatment of a material contaminated with perfluoroalkyl and polyfluoroalkyl substances.

In an embodiment, the material is groundwater.

In an embodiment, the material is residual water from soil washing.

According to one example aspect the present invention provides a process for the treatment of ground water contaminated with perfluoroalkyl and polyfluoroalkyl substances, wherein the contaminated ground water is pumped to the surface and directed to an adsorption step comprising the adsorbent according to any one of the above aspects or embodiments.

According to one example aspect the present invention provides a process for the treatment of ground water contaminated with perfluoroalkyl and polyfluoroalkyl substances, wherein a permeable reactive barrier comprising the adsorbent according to any one of the above aspects or embodiments is located in the path of an aquifer contaminated with perfluoroalkyl and polyfluoroalkyl substances.

According to one example aspect the present invention provides a process for the treatment of spent adsorbent according to any one of the preceding aspects or embodiments, comprising thermal destruction of spent adsorbent.

In an embodiment the thermal destructions occurs at a temperature selected from <700° C., <650° C., <600° C., <550° C., <500° C. or <450° C.

In an embodiment the spend adsorbent is dewatered and dried prior to thermal destruction.

In an embodiment gasses evolved by thermal destruction are scrubbed with an alkaline solution, wherein the alkaline solution is subsequently reacted with calcite to form fluorite.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates PFAS removal from an example high ionic strength solution in terms of % removal of total sum of PFAS compounds and sum PFHxS+PFOS;

FIG. 2 illustrates PFAS removal from an example high ionic strength solution in terms of % removal of individual PFCAs;

FIG. 3 illustrates PFAS removal from an example high ionic strength solution in terms of % removal of individual PFSAs;

FIG. 4 illustrates PFAS removal from an example low ionic strength solution in terms of % removal of total sum of PFAS compounds and sum PFHxS and PFOS;

FIG. 5 illustrates PFAS removal from an example low ionic strength solution in terms of % removal of individual PFCAs;

FIG. 6 illustrates PFAS removal from an example low ionic strength solution in terms of % removal of individual PFSAs;

FIG. 7 illustrates % removal of total sum of PFAS compounds and sum PFHxS and PFOS for hemp seed powder and hemp seed in an example low ionic strength solution;

FIG. 8 illustrates % removal of total sum of PFAS compounds and sum PFHxS and PFOS for hemp seed powder and hemp seed in an example high ionic strength solution;

FIG. 9 illustrates % removal of total sum of PFAS compounds and sum of PFHxS+PFOS as a function of solid to liquid ratio in an example solution;

FIG. 10 shows an overlay of three thermogravimetric analysis (TGA) test; the top series showing mass-loss reactions as a function of time; the middle series showing heat flow of the reactions; and the bottom series showing mass-loss as a function of temperature;

FIG. 11 illustrates % removal of total sum PFAS compounds and sum of PFHxS and PFOS compounds from low ionic strength solutions for HSP and SPI;

FIG. 12 illustrates 0% removal of certain PFCAs compounds for HSP and HSP and SPI;

FIG. 13 illustrates % removal of certain PFSAs compounds for HSP and SPI.

FIG. 14 illustrates the overall analysis procedure for removal experiments including the addition of Total Oxidisable Precursor (TOP) analysis.

FIG. 15 illustrates the removal at low ionic strength of PFOS, PFOA, Σ(PFHxS+PFOS), and ΣPFAS for HSP as a function of solid to liquid ratio.

FIG. 16 illustrates the removal at high ionic strength of PFOS, PFOA, Σ(PFHxS+PFOS), and ΣPFAS for HSP as a function of solid to liquid ratio.

FIG. 17 shows the PFAS removal at HSP 10 g/L for a two-stage (A and B) removal.

FIG. 18 shows the PFAS removal at HSP 50 g/L for a two-stage (A and B) removal.

FIG. 19 shows the PFAS removal at HSP 100 g/L for a two-stage (A and B) removal.

FIG. 20 illustrates the removal kinetics of PFCA using HSP A) at low (natural) ionic strength with HSP only; B) at low (natural) ionic strength with HSP and 1.00 g/L calcite (<150 μm); C) at high ionic strength with HSP only; and D) at high ionic strength with HSP and 1.00 g/L calcite (<150 μm).

FIG. 21 illustrates the removal kinetics of PFSAs using HSP A) at low (natural) ionic strength with HSP only; B) at low (natural) ionic strength with HSP and 1.00 g/L calcite (<150 μm); C) at high ionic strength with HSP only; and D) at high ionic strength with HSP and 1.00 g/L calcite (<150 μm).

FIG. 22 illustrates the removal of particular PFCAs by HSP, HSP with calcite, and activated carbon.

FIG. 23 illustrates the removal of particular PFASs by HSP, HSP with calcite, and activated carbon at different ionic strengths.

FIG. 24 illustrates the pseudo-second order (PSO) model for instantaneous sorption rate (h) as a function of PFSA carbon chain length.

FIG. 25 illustrates the PFAS removal isotherms for PFOS, Σ(PFAS), and Σ(PFHxS+PFOS).

FIG. 26 illustrates modelling of the maximum removal in terms of mass of PFAS removed per gram of solid along with the 95% confidence intervals as derived from the model fitting process, for A) PFOA, B) PFHxA, C) PFOS, D) PFHxS, E) Σ(PFHxS+PFOS), and F) ΣPFAS.

FIG. 27 illustrates the PFHxS+PFOS sorption isotherm using HSP.

FIG. 28 is a schematic diagram of sequential batch reactors.

FIG. 29 illustrates the thermogravimetric (TG) and heat flow curves during combustion of HSP exposed to de-ionised water only.

FIG. 30 illustrates the thermogravimetric (TG) and heat flow curves during combustion of HSP exposed to PFOS at an initial concentration of ˜9.6 mg/L.

FIG. 31 illustrates the infra-red difference spectra of HSP samples exposed to three different concentrations of PFOS.

FIG. 32 shows the FTIR spectra of the HSP control and HSP exposed to PFOS after thermal destruction.

FIG. 33 illustrates the evolved gas analysis during the thermal destruction (at 10° C./min) under an oxygen atmosphere for hemp protein powder exposed to PFOA.

FIG. 34 is a photograph of a laboratory-scale rotary drum vacuum (RDV) showing the removal of the spent HSP solid from the treated water stream.

FIG. 35 shows the % PFAS removal for each of a variety of protein powders prior to normalization.

FIG. 36 illustrates the K_{d} values for each plant protein after normalization for total protein content. Both the A) linear and B) logarithmic plots are displayed.

### PREFERRED EMBODIMENTS

The following modes, given by way of example only, are described in order to provide a more precise understanding of the subject matter of a preferred embodiment or embodiments.

In the Figures, incorporated to illustrate features of an example embodiment, like reference numerals are used to identify like parts throughout the Figures.

It has been surprisingly found that an adsorbent comprising proteins may be effective in the removal of aqueous PFASs. In an embodiment, it has been surprisingly found that an adsorbent comprising plant proteins may be effective in the removal of aqueous PFASs. Example non-limiting plant proteins which may act as an adsorbent for PFASs may include: edestin, albumin proteins, globulin proteins such as glycinin and beta-glycinin, and/or lupin. In some embodiments, it has been found that the inclusion of calcite in an adsorbent comprising a plant protein may enhance the effectiveness of the adsorbent. It is to be understood that the invention is not limited to the proteins listed above, and may include proteins with similar properties, such as structural similarities and/or similar configurations of functional groups and/or amino acids.

In a particular embodiment, it has been surprisingly found that an adsorbent comprising hemp seed proteins may be effective in the removal of aqueous PFASs. Hemp seed protein may be in the form of hemp seeds, crushed hemp seeds, hemp seed powder (referred to herein as HSP, hemp seed powder may also be referred to as “Hemp Powder Protein” or HPP), hemp protein isolate, mixtures thereof, or any other suitable form. Without wishing to be bound by theory, it is thought that the hemp seed proteins edestin and/or albumin may be an effective substrate for PFASs remediation by adsorption.

It has been found that use an adsorbent comprising substantially only hemp seed protein may be remove PFASs from water to below Australian drinking water standards. For example, use of an adsorbent comprising substantially only hemp seed protein may achieve about 98-99% removal of PFSA substances from a low ionic strength solution, and may achieve about 96-97% removal of PFSA substances from a high ionic strength solution.

It has been found that an adsorbent comprising hemp seed protein and calcite may be effective in the removal of aqueous PFASs. In some embodiments, inclusion of calcite may enhance the effectiveness of an adsorbent in removing certain PFASs. By way of example, an adsorbent with approximately equal parts hemp seed protein and granular limestone may increase of removal of PFHxA and PFHpA at low and high ionic strengths. For example, use of an adsorbent comprising equal parts hemp seed protein and calcite may increase removal of PFHxA from about 72% to >99.9% and PFHpA from 78.5% to >99.9% in low ionic strength solution of about 6 mS/cm when compared to use of hemp seed protein without calcite. Use of an adsorbent comprising equal parts hemp seed protein and calcite in solutions of high ionic strength may increase removal of PFHxA from about 42% to about 76% and PFHpA from about 69% to about 84%. Without wishing to be bound by theory, it is though that an adsorbent comprising hemp seed protein and calcite may enhance the adsorption properties for certain species of PFASs beyond the mere additive adsorption properties of hemp seed protein and calcite considered separately. It is to be understood that an adsorbent comprising equal parts protein and calcite is an example embodiment, and adsorbents featuring different ratios may be used.

In an embodiment, an adsorbent comprising soy protein may be effective in the removal of aqueous PFASs. Soy protein may be in the form of soy beans, crushed soy beans, soy bean meal, soy protein isolate, mixtures thereof or any other suitable form. Without wishing to be bound by theory, it is thought that the soy proteins glycinin and/or beta-conglycinin may be effective in the removal of aqueous PFASs. Further, inclusion of calcite may increase the effectiveness of an adsorbent comprising soy protein.

In some embodiments, the adsorbent may comprise one or more proteins selected from hemp seed protein, soy protein, pea protein, egg protein, whey protein and lupin protein.

In an embodiment, the adsorbent comprising protein as hereinbefore described may be used in conjunction with a pump and treat system whereby groundwater contaminated with PFASs substances is pumped to the surface for treatment. The treatment process may involve an adsorption step where the PFASs contaminated water is contacted with the adsorbent as herein described. For example, the adsorbent may contained in packed beds through which contaminated groundwater traverses. In certain embodiments, the packed bed may include an inert substance to increase the interstitial space in the packed bed thereby increasing permeability and flowrate therethrough in order to achieve an appropriate residence time. Configuring the permeability of the packed bed may also facilitate economic design of the hydraulic circuit used to direct contaminated water through the packed bed, for example, by reducing pumping head requirements. The inert substance may be glass beads or any other suitable material, and may be distributed with the adsorbent in the packed bed. In an embodiment, the adsorbent and inert substance may be provided as a pre-mixed product to facilitate easier charging of the adsorption apparatus such as a packed bed. Remediated water having undergone the adsorption step may then be returned to an aquifer, or discharged to a surface watercourse.

In an embodiment the adsorbent as herein described may be used to treat PFASs contaminated ground water using an in situ permeable reactive barrier (PRB) process. Such a process may involve a subsurface wall which may be installed in a substantially perpendicular direction to the hydraulic gradient of the PFASs contaminated groundwater. As the contaminated ground water passes through the PRB comprising the adsorbent, the water may be remediated of PFASs. In certain embodiments, the adsorbent in the PRB may be combined with some material to increase permeability therethrough to achieve appropriate residence time. Such a material may include gravel, for example of size 10 mm to 20 mm, calcite or any other suitable material.

In an embodiment the adsorbent as described herein may be used to treat residual water generated from washing soils. For example, residual wash water generated by washing PFAS contaminated soils may become contaminated with PFAS compounds, and thus may be treated using the adsorbents as herein described.

In an embodiment the adsorbent as described herein may be used to treat PFAS contaminated water by way of a series of batch reactors, wherein contaminated water passes through each reactor in sequence, and wherein each sequential reactor provides a further amount of adsorbent to further reduce the level of PFASs in the water. The effluent of a first reactor in a series becomes the influent of a second reactor in a series.

In an embodiment, once the adsorbent has become spent, it may be disposed of by thermal destruction. In some embodiments, the spend adsorbent may first be dewatered and dried, for example by air drying, before being thermally destroyed. It has been surprisingly found that the spent adsorbent as herein described may be thermally destroyed at lower temperatures than may be otherwise anticipated. Without wishing to be bound by theory, it is thought that the sorption of PFASs may affect the bonding strength of the organic component of the hemp seed protein, thereby enhancing the thermal destruction process. In an embodiment, spent adsorbent may undergo thermal destruction at a temperature of about <700° C. In an embodiment, spent adsorbent may undergo thermal destruction at a temperature of about <650° C. In an embodiment, spent adsorbent may undergo thermal destruction at a temperature of about <600° C. In an embodiment, spent adsorbent may undergo thermal destruction at a temperature of about <550° C. In an embodiment, spent adsorbent may undergo thermal destruction at a temperature of about <500° C. In an embodiment, spent adsorbent may undergo thermal destruction at a temperature of about <450° C.

In an embodiment, gasses evolved by the thermal destruction process may be scrubbed, for example using an alkaline solution. The alkaline solution may then be reacted to with calcite to form fluorite.

Many modifications will be apparent to those skilled in the art without departing from the scope of the present invention.

### Example 1

Two samples (A & B) of approximately 1 litre were obtained from water flowing out of the drains under Medowie Road from RAAF Williamtown into Moor's Creek in NSW, Australia. The samples were placed in a cooler bag with ice bricks for transport to the University of Newcastle Geoenvironmental laboratories.

Sample A was spiked with analytical grade (Sigma Aldrich) perfluorooctanoic acid (PFOA) whilst sample B was combined 1:1 with sample A to form sample C. Sample C was then split equally to form sample D to which enough KCl was added to increase the ionic strength to ˜45 mS/cm. The samples were stored at 4° C.

A set of batch reactor samples were setup to determine the extent of PFAS removal using five different sorbents (S1-S5). Batch tests were done in PFAS approved plastic ware, capped and left for at least 3 days in an end-over-end stirrer to equilibrate. Blanks were included in each batch test using De-Ionized (DI) water and DI water made up to ˜45 mS/cm with KCl. All PFAS analyses were done at ALS laboratories, Sydney under the standard suite of 28 analytes as listed in Table 1.

Laboratory sampling for pH, electrical conductivity (EC), and major cations and anions were done on subsamples taken from each batch test. pH electrode (Orion 9165BN) calibration was completed using pH 4, 7 and 10 NIST buffers until a slope of 92-102% was obtained. EC calibration was done using an Orion Star A322 meter and a 1413 mS/cm standard as per manual instructions. Anions and cations were analysed using a Dionex ICS5000 ion chromatograph running Chromeleon 6.8 software and equipped with an AS18/AG18 anion analytical/guard columns utilizing 30 mM potassium hydroxide (KOH) eluent. For cations, CS12A/CG12 analytical/guard columns utilizing 20 mM methanesulfonic acid (MSA) eluent. Five point calibration was carried out prior to analysis using a Dionex anion combined seven ion standard, and Dionex cation combined six ion standard.

A key parameter in remediation is the amount of sorbent required to remove a certain concentration of contaminant. This requires the development of a sorption isotherm for each PFAS compound of interest.

Sorption experiments have been completed for the development of sorption isotherms for the PFAS/hemp seed powder system. For these experiments ˜50 L of groundwater was obtained from the most contaminated monitoring well (MW187s) at Williamtown RAAF Base, NSW. This groundwater sample has more than 40 times the amount of PFHxs+PFOS in experiments using water samples B, C & D (Table 1). Sorption isotherms experiments were done via the batch reactor methodology outlined above.

Thermogravimetric analysis with differential scanning calorimetry (TGA-DSC) was done using a Mettler-Toledo TGA2 instrument running STARe software.

The PFAS chemistry used in these experiments is shown in Table 1. The term PFAS is used to describe all per- or polyfluoroalkyl species, however this can be further divided into classes and then individual substances as shown in Table 2.

TABLE 1
Major PFAS analytes found in groundwater at Williamtown, NSW compared to the PFDA
spiked water sample obtained from Moor's Drain, Williamtown and sample
taken from MW187s a moitoring well near the Williamtown BAAF base.

| | | Highest | Intial | | | |
|---|---|---|---|---|---|---|
| | | groundwater | Chemistry | | | |
| | | concentration | Sample B | | | |
| | | at | (spiked | Intial | Initial | |
| Analyte | | Williamtown | with | Chemistry | Chemistry | |
| Grouping | Analyte | (μg/t.) | PFOA) | Sample C | Sample D | MW187s |
| Perfluoroalkane | PFOS | 98.2 | 2.94 | 2.83 | 1.65 | 130.0 |
| Sulfonates | PFHxS | 18.6 | 1.05 | 0.76 | 0.76 | 32.0 |
| (PFSAs) | ΣPFOS + | | 3.99 | 3.59 | 2.41 | 162 |
| (μg/t.) | PFHxS | | | | | |
| | PFBS | 4.07 | 0.07 | 0.06 | <0.02 | 3.97 |
| Perfluoroalkyl | PFOA | 2.94 | 7680.0 | 696 | 2150 | 6.82 |
| Carbooxylates | PFHxA | 8.05 | 5.64 | 3.95 | 0.62 | 9.34 |
| (PFCAs) | PFHpA | 2.93 | 30.7 | 26.3 | 5.62 | 1.5 |
| (μg/t.) | | | | | | |
| Fluorotelomers | 6:2 FTS | 0.42 | <0.05 | <0.05 | <0.05 | <0.05 |
| (μg/t.) | | | | | | |
| | ΣPFAS | | 7720 | 1000 | 2160 | 194 |
| | (TOTAL) | | | | | |
| | Electrical | 1.29* | 0.16 | 0.11 | 42.3 | |
| | Conductivity | | | | | |
| | (m5/cm) | | | | | |
| | pH | 5.79* | 6.68 | 6.78 | 6.2 | |

*Average of 146 groundwater samples (pH range 3.95-8.56; EC range 0.03-28.6 mS/cm).

TABLE 2
Nomenclature of the most common 28 per- and polyfluoro substances (PFASs) as analysed
by ALS Environment Laboratories (ALS ENVIRONMENTAL, 2016). Key PFAS chemicals in bold.

| | | | No. C |
|---|---|---|---|
| CLASS | SUBSTANCE | Molecular Formula | atoms |
| Perfluoroalkyl | Perfluorobutane sulfonic acid (PFBS) | C₄F₉SO₃ [symbol] | 4 |
| Sulfonic Acids | Perfluoropentane sulfonic acid (PFPeS) | C₅F₁₁SO₃ [symbol] | 5 |
| (PFSAs) | Perfluorohexane sulfonic acid (PFHxS) | C₆F₁₃SO₃ [symbol] | 6 |
| | Perfluoroheptane sulfonic acid (PFHpS) | C₇F₁₅SO₃ [symbol] | 7 |
| | Perfluorooctane sulfonic acid (PFOS) | C₈F₁₇SO₃ [symbol] | 8 |
| | Perfluorodecane sulfonic acid (PFDS) | C₁₀F₂₁SO₃ [symbol] | 9 |
| Perfluoroalkyl | Perfluorobutanoic acid (PFBA) | C₃F₇CO₂ [symbol] | 4 |
| Carboxylic | Perfluoropentanoic acid (PFPeA) | C₄F₉CO₂ [symbol] | 5 |
| Acids (PFCAs) | Perfluorohexanoic acid (PFHxA) | C₅F₁₁CO₂ [symbol] | 6 |
| | Perfluoroheptanoic acid (PFHpA) | C₆F₁₃CO₂ [symbol] | 7 |
| | Perfluorooctanoic acid (PFOA) | C₇F₁₅CO₂ [symbol] | 8 |
| | Perfluorononanoic acid (PFNA) | C₈F₁₇CO₂ [symbol] | 9 |
| | Perfluorodecanoic acid (PFDA) | C₉F₁₉CO₂ [symbol] | 10 |
| | Perfluoroundecanoic acid (PFUnDA) | C₁₀F₂₁CO₂ [symbol] | 11 |
| | Perfluorododecanoic acid (PFDoDA) | C₁₁F₂₃CO₂ [symbol] | 12 |
| | Perfluorotridecanoic acid (PFTrDA) | C₁₂F₂₅CO₂ [symbol] | 13 |
| | Perfluorotetradecanoic acid (PFTeDA) | C₁₃F₂₇CO₂ [symbol] | 14 |
| Perfluoroalkyl | Perfluorooctane sulfonamide (FOSA) | C₈F₁₇SO₂NH₂ | 8 |
| Sulfonamides | N-Methyl perfluorooctane sulfonamide (MeFOSA) | C₈F₁₇SO₂NHCH₃ | 9 |
| (FOSAs) | N-Ethyl perfluorooctane sulfonamide (EtFOSA) | C₈F₁₇SO₂NHCH₂CH₃ | 10 |
| | N-Methyl perfluorooctane sulfonamidoethanol (MeFOSE) | C₈F₁₇SO₂N(CH₂)₂CH₃OH | 11 |
| | N-Ethyl perfluorooctane sulfonamidoethanol (EtFOSE) | C₈F₁₇SO₂N(CH₂)₃OH | 11 |
| | N-Methyl perfluorooctane sulfonamidoacedic acid (MeFOSAA) | C₈F₁₇SO₂NCH₃CH₂CO₂ | 11 |
| | N-Ethyl perfluorooctane sulfonamidoacedic acid (EtFOSAA) | C₈F₁₇SO₂N(CH₂)₂CH₃CO₂ | 11 |
| (n:2) | 4:2 Fluorotelomer sulfonic acid (4:2FTS) | C₆H₄F₉SO₃ [symbol] | 6 |
| Fluorotelomer | 6:2 Fluorotelomer sulfonic acid (6:2FTS) | C₈H₄F₁₃SO₃ [symbol] | 8 |
| Sulfonic Acids | 8:2 Fluorotelomer sulfonic acid (8:2FTS) | C₁₀H₄F₁₇SO₃ [symbol] | 10 |
| (FTSs) | 10:2 Fluorotelomer sulfonic acid (10:2FTS) | C₁₂H₄F₂₁SO₃ [symbol] | 12 |

[symbol]

indicates data missing or illegible when filed

Initial testing used the following sorbents: (1) a hemp seed protein powder (HSP); (2) hemp seed (HS); (3) sphagnum peat moss; (4) humic acid (analytical grade (Sigma Aldrich chemicals)); (5) calcium carbonate (calcite sourced from DML Lime, Attunga, NSW); (6) various mixtures of sorbents 1, 2, & 5. As sorbents 3 & 4 did not show any removal of PFAS contaminants, they were removed from the test schedule.

Laboratory analysis returns the breakdown of all PFAS species found in a sample as well as the total (sum) of all PFASs and the total of PFHxS+PFOS. Existing studies on PFHxS suggest that this chemical can cause effects in laboratory test animals similar to the effects caused by PFOS. However, based on available studies, PFHxS appears to be less potent in animal studies than PFOS. Consequently, PFHxS and PFOS concentrations are a reported as a combined concentration.

The Commonwealth Department of Health has established health based guidance values and currently the maximum drinking water values are 0.07 μg/L for PFHxS+PFOS and 0.56 μg/L PFOA. These are the only PFAS species to have guidance values.

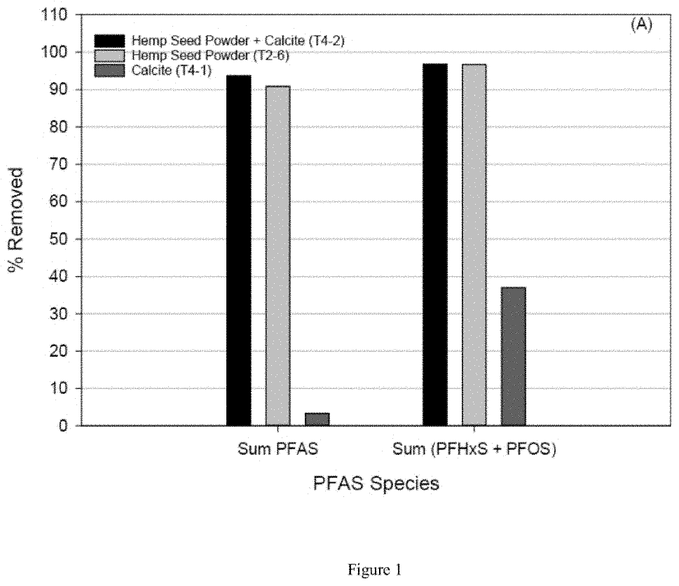

FIG. 1 shows the removal at high ionic strength (Water D; Table 1) of total (sum) PFAS and PFHxS+PFOS. HSP by itself removed ˜90.8% of the initial total PFAS (2160 μg/L) and ˜96.7% of the initial PFHxS+PFOS (2.41 μg/L) giving a final concentration of 0.055 μg/L (PFHxs+PFOS) and ˜198.7 μg/L PFAS. It is evident that calcite by itself performs poorly in comparison to HSP and that the addition of calcite to HSP does not change the amount of PFHxS+PFOS removed but increases the total PFAS removed by ˜3.1%.

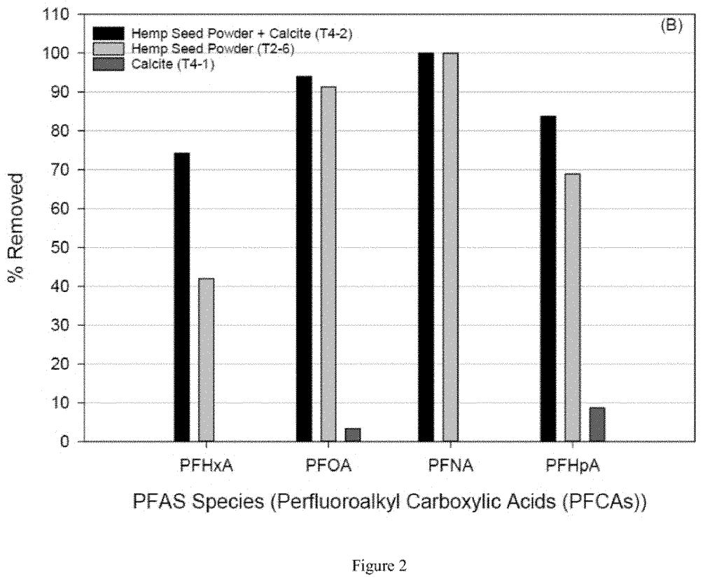

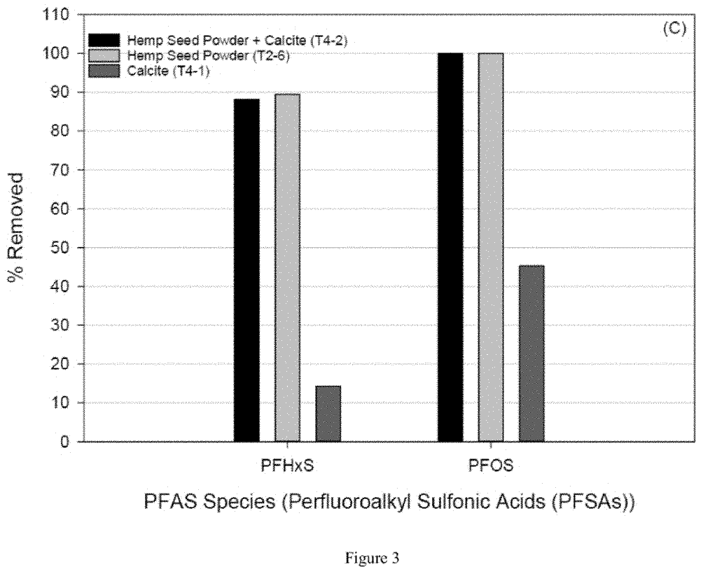

FIG. 2 shows removal at high ionic strength for certain PFCAs compounds, whereas FIG. 3 shows removal at high ionic strength for certain PFSAs compounds. FIG. 2 shows that, with the addition of calcite (1:1) to HSP, there is a defined trend in the removal of PFCAs, with removal increasing with decreasing carbon chain length. For example, with PFNA (9C (carbon chain)) there is no difference in its removal, with PFOA (8C) removal increased by ˜2.7%; PFHpA (7C) removal increased by ˜14.8%; and PFHxA (6C) removal increased by ˜32.3%.

For the PFSAs (FIG. 3) the addition of calcite has no effect on PFOS removal with final concentrations below the laboratory limit of reporting (>99.9% removal) with HSP alone. There is <1.4% difference in the shorter chain (6C) PFHxS removal indicating that the presence of calcite does not significantly affect PFSA removal by HSP.

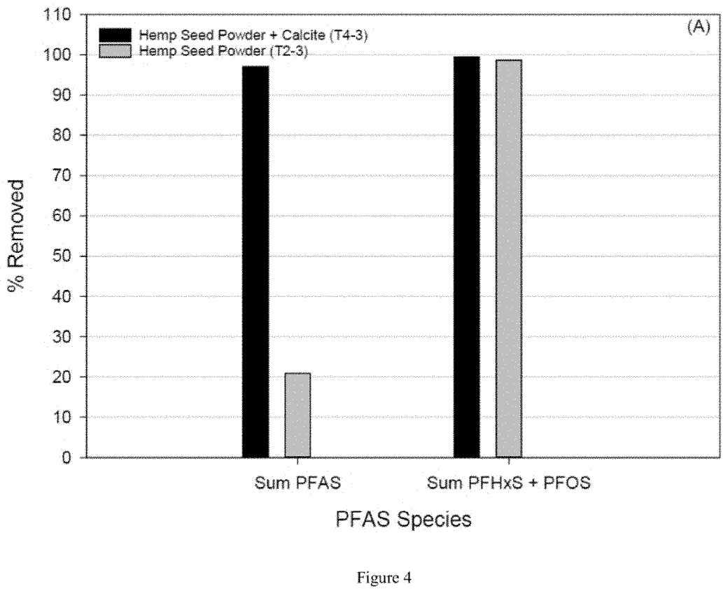

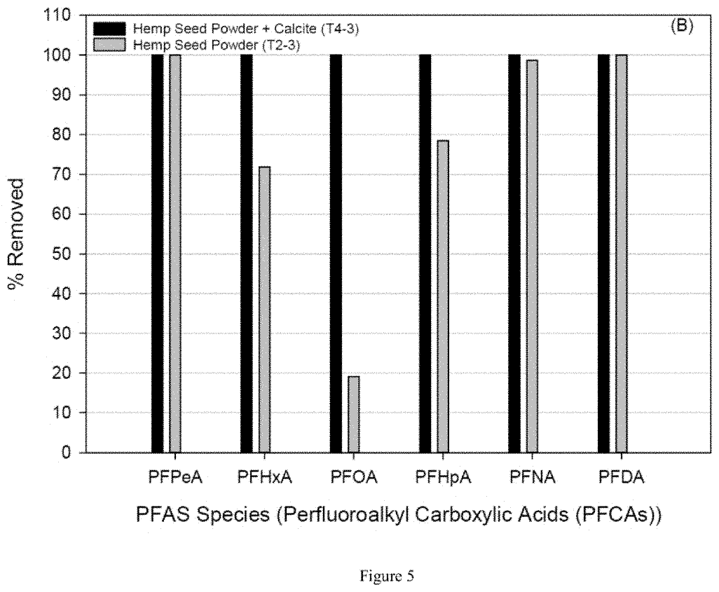

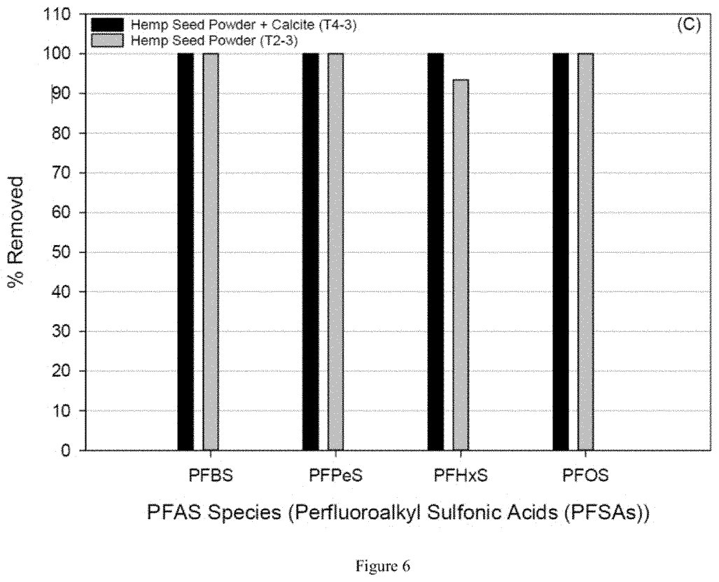

Due to lack of sample volume, no calcite (alone) experiments were done in the low ionic strength series. FIGS. 4 to 6 shows the removal of PFAS from low ionic strength solution (Sample C, Table 1) using HSP and HSP+calcite at 100 g/L. From FIG. 5 it is apparent that the low removal (˜19.1%) of PFOA is erroneous given that the same sample (not shown) using only 70 g/L solid to liquid ratio indicated ˜69.9% removal.

The addition of calcite to HSP resulted in a PFOA removal >99.9% (below laboratory limit of detection) from an initial concentration of 969 μg/L.

As found with the high ionic strength experiments, the addition of calcite to HSP appears to have a positive effect on the removal of PFCAs with increasing removal with decreasing chain length (with the exception of the PFOA error as discussed above). For example, FIG. 5 shows no increase for the 10C (carbon chain) PFDA, 1.4% increase for PFNA (9C), 21.5% increase for PFHpA (7C), and 29.2% increase for PFHxA (6C). FIG. 6 shows that the addition of calcite did not affect PFOS removal, however, there was a slight (˜4.0%) increase in PFHxS removal observed at low ionic strength. All other PFAS species present in the initial control sample were removed to below the laboratory limit of reporting (FIGS. 5-6) after the addition of calcite to HSP.

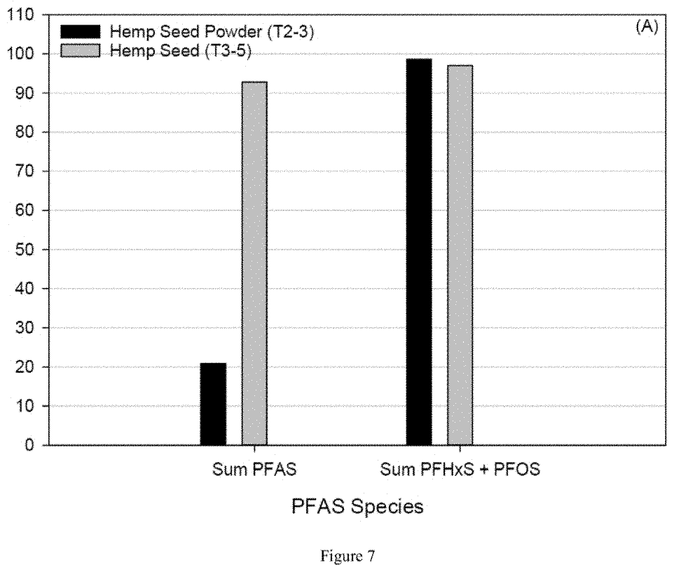

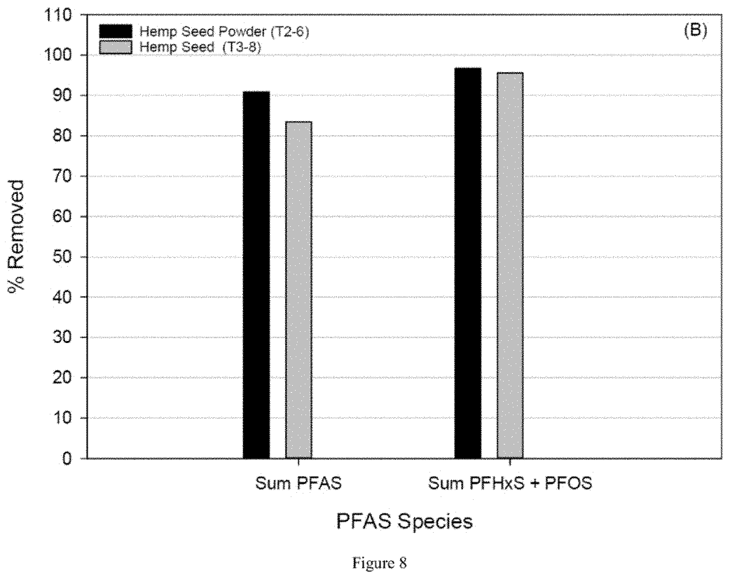

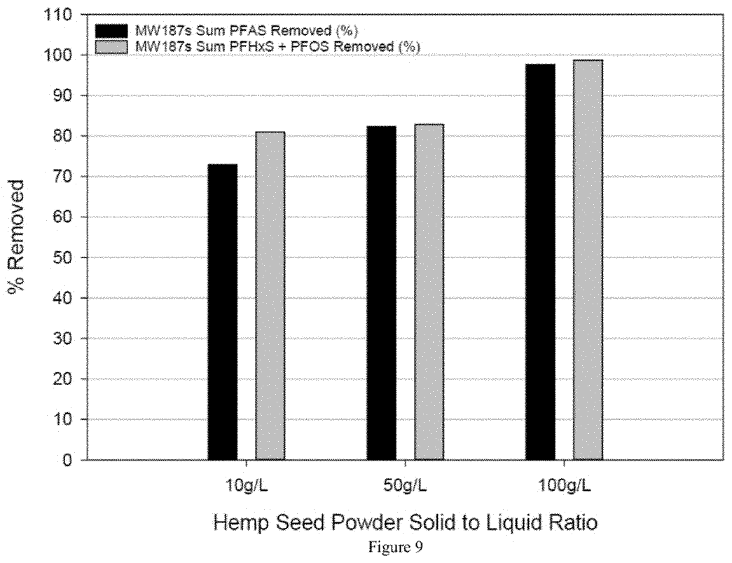

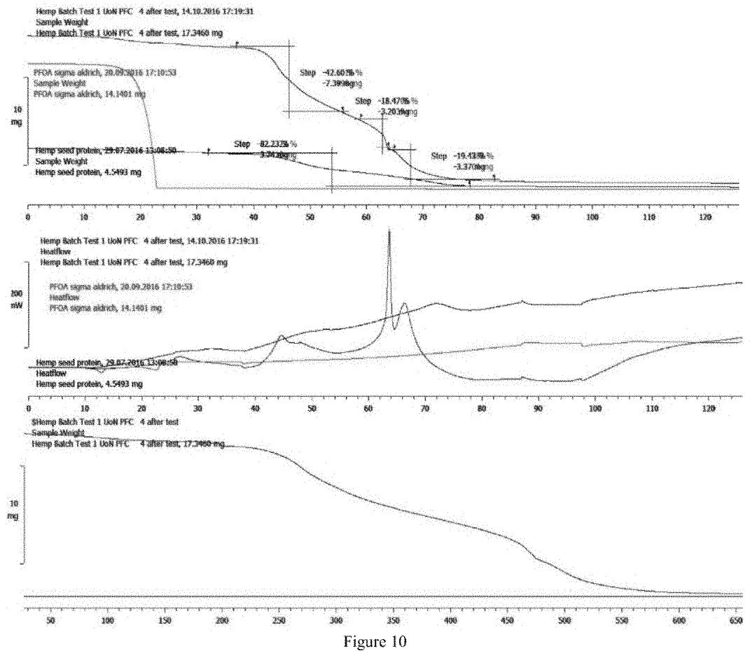

To compare the PFAS removal ability of hemp seed powder to the hemp seed (not powdered) a series of comparative experiments were done. FIG. 7 shows the removal comparison at low ionic strength and it appears that HSP appears to remove much less total (sum) PFAS than HS. This is due to the erroneous PFOA result in this experiment (as discussed above) and therefore the total (sum) PFAS removal should be disregarded. At high ionic strength (FIG. 8) HSP removed only ˜7.3% more total (sum) PFAS than HS. For the total amount of PFHxS+PFOS removed, less than ˜1% difference between HSP and HS was observed at high ionic strength. This was supported by the low ionic strength results (FIG. 7). Consequently, depending on cost it may be beneficial to use HS rather than the more refined HSP.

FIG. 9 shows the removal of total PFAS and PFHxS+PFOS as a function of HSP solid-to-liquid ratio. As expected from a sorption reaction, contaminant removal increases with increasing mass with 100 g/L HSP removing ˜96.7% PFOA to 0.22 μg/L well below the Australian Drinking Water Guidelines (ADWG). However, despite removing ˜98.7% of the initial PFHxS+PFOS, the final concentration (˜2.12 μg/L) still exceeds the ADWG of 0.07 μg/L.

FIG. 10 shows the overlay of three TGA test using analytical grade PFOA, unreacted hemp seed powder and HSP reacted with water Sample B. The top series shows as a function of time the mass loss reactions, the middle series shows the heat flow of the reactions, and the bottom series shows mass loss as a function of temperature (° C.).

PFOA loses its entire mass (˜99.92%) by 140° C. with two exothermic peaks at ˜65° C. and 125° C.

Unreacted HSP appears to have only one major mass loss occurring between ˜180-430° C. However, at ˜82.2% the mass loss is significant and reflects the amount of organic matter (protein) in the sample. In contrast the reacted HSP has a total mass loss of ˜80.49% over three distinct regions (˜42.6% between 210-260° C.; ˜18.47% between 300-380° C.; and ˜19.42% between 380-450° C.) indicating that the sorption of PFAS has changed the bonding strengths of the organic (perhaps proteins) component in the HSP. The total mass lost is within 1.5% of the un-reacted HSP indicating that the spent HSP appears to be completely destroyed by ˜450° C.

### Example 2

Approximately 50 L was obtained from monitoring well MW187s at Williamstown RAAF Base, NSW, Australia. Table 3 lists the major PFAS analytes and concentrations of this sample as determined by ALS laboratories, Sydney, NSW, Australia. The term PFAS is used to describe all per- or polyfluoroalky species, which can be divided into subclasses and individual species as shown in Table 2.

TABLE 3
Major PFAS analytes found in ground water from
monitoring well (MW) 187 as used in Example 2.

| Analyte Grouping | Analyte | MW187s |
|---|---|---|
| Perfluoroalkane | PFOS | 91.7 |
| Sulfonates | PFHxS | 20.7 |
| (PFSAs) | PFBS | 3 |
| (μg/L) | ΣPFOS + PFHxS | 112 |
| Perfluoroalkyl | PFOA | 4.3 |
| Carboxylates | PFHxA | 6.3 |
| (PFCAs) | PFHpA | 2.18 |
| (μg/L) | PFBA | 3.3 |
| Fluorotelomers | 6:2 FTS | <0.05 |
| (μg/L) | | |
| | ΣPFAS (TOTAL) | 194 |

An experimental methodology as provided in Example 1 was followed wherein soy protein isolate powder (SPI) (natural; sourced from a health food store) is compared to removal using hemp seed powder (HSP). Experiments using groundwater from MW187s were conducted on both protein powders at equivalent solid-to-liquid ratios (100 g/L) to compare any differences in removal.

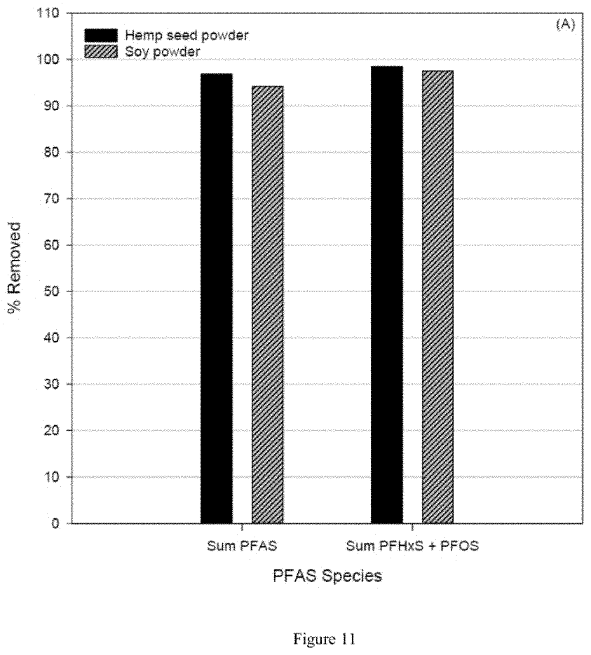

FIG. 11 compares the removal of total sum PFAS compounds as well as the total sum of PFHxS and PFOS for both HSP and SPI. As indicated HSP and SPI display similar efficacy as adsorbents, with HSP removing ˜2.6% more total PFAS than SPI, whereas the difference in PFHxS and PFOS removal showed <1% difference.

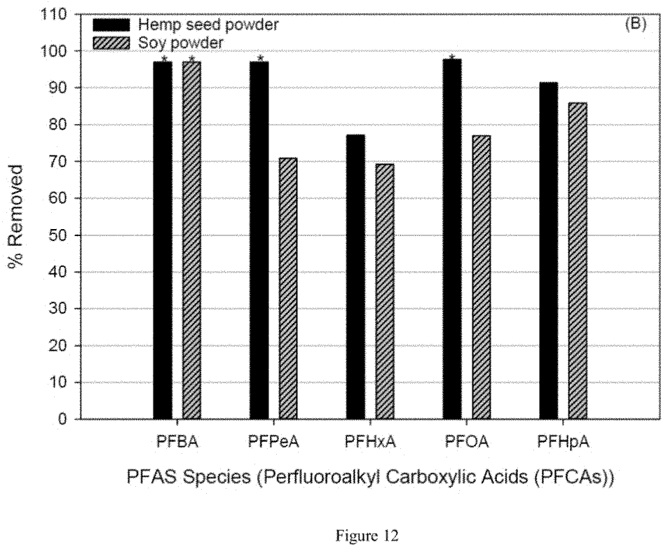

Referring now to FIG. 12, shown is a comparison of the removal of selected PFCAs for HSP and SPI. FIG. 12 indicates that the efficacy of HSP may be generally greater than SPI in regards to PFCAs, with PFOA and PFPeA being removed below the laboratory limit of reading (<LOR) using HSP as an adsorbent, as indicated by the * in FIG. 12. PFOA and PFPeA removal using HSP was about >20.5% and about >26% higher respectively compared with using DPI as an adsorbent. PFHxA was about >8% greater for HSP compared to SPI.

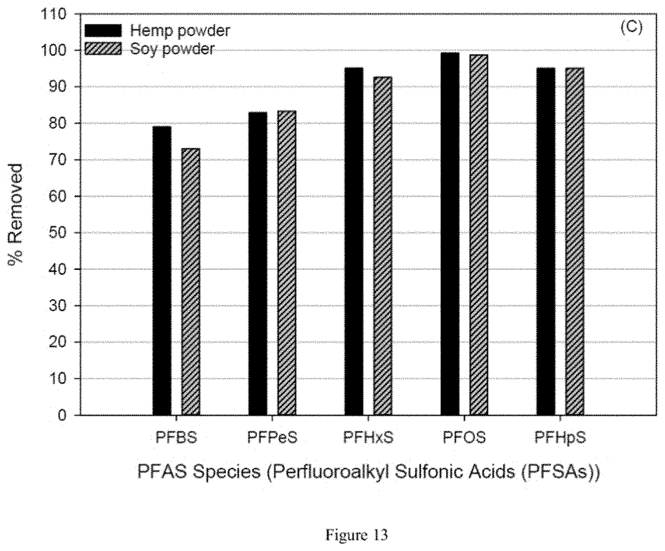

Referring now to FIG. 13, shown is a comparison of the removal of selected PFSAs for HSP and SPI. FIG. 13 indicates that little difference exist in the ability of HSP and SPI to remove PFSA species, with >99% PFOS removal observed irrespective of the sorbent and >95% PFHxS removed by HSP and 92.5% removed by SPI.

### Example 3

Groundwater from monitoring well MW 187s was diluted by volume to achieve a concentration of 10%, 25%, 50% and 100% (undiluted) of the initial groundwater according (Table 3). Sorption isotherms were then developed for HSP and SPI at a solid to liquid ratio of 100 g/L.

The adsorption distribution coefficient (K₄) is used environmentally to estimate the removal of a contaminant during treatment with a given sorbent material. K_{d} is determined from the analysis of a sorption isotherm where the amount of contaminant removed per mass of sorbent (Cₛ; μg/kg) is compared to the final concentration of containment in solution (Cₛ; μg/L). Accordingly, K_{d} is expressed in units of L/kg.

For a linear relationship Cₛ=K_{d}Cₑ with high K_{d} values indicating that the sorbent has a high affinity for the containment. Other sorption isotherms relationships exist such as the Freundlich or Langmuir isotherm but these describe non-linear contaminant sorption. In the experiments presented herein, for all PFAS species present the removal over the concentration range tested general followed a linear response.

The linear isotherm for PFOA and PFBA with HSP showed an “infinite” removal response as the final concentration, in all cases, was reduced to below the laboratory limit of reporting. Table 4 below gives the K_{d} values obtained for PFOS and PFOA using HSP are very large (>1000) and infinite respectively, however, the true value for PFOA will depend on further experiments using higher initial concentrations of PFOA.

TABLE 4
PFAS partitioning coefficients using hemp protein powder
(HSP) and soy protein isolate (SPI) at 100 g/L

| PFAS species | K_{d} (L/kg) using HPP | K_{d} (L/kg) using SPI |
|---|---|---|
| PFOA | “infinite” | 29.7 |
| PFBA | “infinite” | “infinite” |
| PFHxA | 35.2 | 23.2 |
| PFOS | 1040.5 | 765.6 |
| PFBS | 37.7 | 26.3 |
| PFHxS | 175.8 | 125.8 |

### Example 4

Using groundwater obtained from the most contaminated monitoring well (MW187s) identified at Williamtown RAAF base, batch sorption tests were carried out to determine the respective sorption isotherms for the individual PFAS components. An additional sample taken from Moor's Drain adjacent to the Williamtown RAAF base was spiked with analytical grade PFOA and used in some experiments, as previously described. Table 5 shows the PFAS concentrations in each of these samples.

TABLE 5
Major PFAS analytes in groundwater from monitoring
well MW187s at Williamtown, NSW and a PFOA spiked
water sample obtained from Moor's Drain, Williamtown.

| | | Moor's | Williamtown |
|---|---|---|---|
| | | Drain | RAAF |
| | | (spiked with | groundwater |
| Analyte Grouping | Analyte | PFOA) | MW187s |
| Perfluoroalkane | PFOS | 2.94 | 130.0 |
| Sulfonates | PFHxS | 1.05 | 32.0 |
| (PFSAs) | ΣPPOS + PFHxS | 3.99 | 162 |
| (μg/L) | PFBS | 0.07 | 3.97 |
| Perfluoroalkyl | PFOA | 766 mg/L | 6.82 |
| Carboxylates | PFHxA | 5.64 | 9.34 |
| (PFCAs) | PFHpA | 30.7 | 1.5 |
| (μg/L) | | | |
| Fluorotelomers | 6:2 FTS | <0.05 | <0.05 |
| (μg/L) | | | |
| | ΣPFAS (TOTAL) | 770 mg/L | 194 |
| | Electrical | 0.16 | <1 |
| | Conductivity | | |
| | (mS/cm) | | |
| | pH | 6.68 | 6.8 |

The individual chemicals belonging to PFAS classes of PFCAs, PFSAs, sulfonamides and telomeres are shown above in Table 2. No chemicals belonging to the sulfonamide or telomere classes were detected for Williamtown, i.e. all were below the laboratory limit of reporting.

Batch tests were conducted in 120 mL PFAS approved (polypropylene) plastic ware, capped and left for at least 3 days in an end-over-end stirrer to equilibrate at ˜20° C. Blanks were included in each batch test using de-Ionized (DI) water or DI water made up to ˜45 mS/cm with KCl for high ionic strength tests. All PFAS analyses were done at ALS laboratories, Sydney (NATA accredited) using modified USEPA method 315 for a standard suite of 28 PFAS analytes as listed in Table 2.

At the end of the equilibration period, samples were centrifuged at 20° C. and the supernatant decanted into clean polypropylene jars. These were refrigerated until transfer to a NATA accredited lab (ALS laboratories) typically the same day (or <24 hours). A small aliquot (<5 mL) of each sample was taken for pH, electrical conductivity (EC). The remaining solid was subsampled (<40 mg) and analysed by thermogravimetric-differential scanning calorimetry (TGA-DSC) using a Mettler Toledo Star TGA-DSC under an O₂ or N₂ atmosphere at 40 mL/min and a temperature gradient of 10° C. per minute from ˜30 to 1080° C.

Total Oxidizable Precursor (TOP) Analysis was conducted. The TOP analysis transforms the numerous PFAS precursors that generally exist in a contaminated sample to those compounds detected as part of the standard suite of analytes. This gives a worst case scenario as it “reveals” the potential unidentified hidden PFAS chemicals that may exist in a sample.

However, in accordance with other publications and analysis of the results obtained thus far, the present inventors have reservations on the reliability of the laboratory TOP analyses. Other publications (https://www.envstd.com/top-analysis-more-to-consider-when-monitoring-polyfluorinated-alkylated-substances/) indicate that further research using TOP analysis is needed to define its limitations. Furthermore, TOP analysis should not be used at this time as proof of total PFAS degradation, or as a quantitative indication for human or ecological risk assessment.

Analysis of results pre and post TOP (identified herein as “−TOP” or “+TOP”) indicate that TOP analysis may give results that are false or misleading. For example, experiments without TOP analysis show concentrations of PFOS ˜130 μg/L, but with TOP ˜76.5 μg/L. Additionally, percentage removal calculations vary widely depending on which result set (+TOP or −TOP) are used. Further investigation into the validity of TOP analysis is required. Nevertheless, as the TOP analysis appears to be a requirement for publication and acceptance of remediation data, it was carried out and the results are included in the present application.

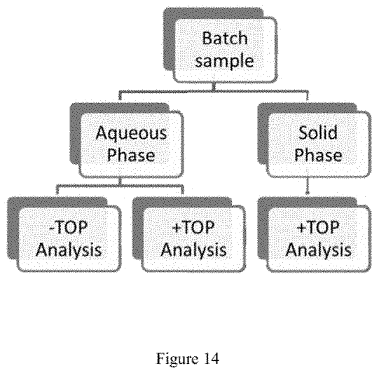

The overall analysis procedure including the addition of the TOP analysis is shown in FIG. 14. TOP analysis was done (indicated by +TOP) on solids and aqueous phases. Aqueous phases were also analysed for non-oxidised (−TOP) sampled to enable the amount of precursor PFAS compounds in the sample to be determined.

Batch sorption tests were carried out according to the experimental matrices of Tables 6 and 7 below. Table 6 represents the experimental matrix for low (natural) ionic strength batch tests using MW187s groundwater. The groundwater was either undiluted (100%) or diluted to 50, 25, 10, or 1% and mixed with hemp seed powder (HSP) to give a final solid to solution ratio of 0 (control) to 200 g/L. In addition to these experiments, blanks using de-ionized water at each ionic strength to determine PFAS sources/sinks from sorbent were also tested.

TABLE 6
Experimental matrix for hemp protein powder at low (natural)
ionic strength as a function of solid to liquid (S:L) ration.

| S:L ratio | Low Ionic Strength MW187s groundwater | | | | | | | | | |
|---|---|---|---|---|---|---|---|---|---|---|
| 0 (control) | 100% | ✓ | 50% | ✓ | 25% | ✓ | 10% | ✓ | 1% | ✓ |
| 1 | 100% | ✓ | 50% | ✓ | 25% | ✓ | 10% | ✓ | 1% | |
| 10 | 100% | ✓ | 50% | ✓ | 25% | ✓ | 10% | ✓ | 1% | ✓ |
| 25 | 100% | | 50% | | 25% | | 10% | | 1% | |
| 50 | 100% | ✓ | 50% | ✓ | 25% | ✓ | 10% | ✓ | 1% | ✓ |
| 75 | 100% | | 50% | | 25% | | 10% | | 1% | |
| 100 | 100% | ✓ | 50% | ✓ | 25% | ✓ | 10% | ✓ | 1% | ✓ |
| 200 | 100% | ✓ | 50% | ✓ | 25% | ✓ | 10% | ✓ | 1% | ✓ |

Table 7 shows the experimental matrix for the high ionic strength experiments using MW187s groundwater to determine the effects of salinity on PFAS removal using HSP. Potassium chloride was added to the respective groundwater dilutions to achieve a final electrical conductivity of ˜49 mS/cm. The presence of a tick symbol indicates completed experiments; conversely, those without a tick symbol were either not done or replaced. For example, solid to liquid ratio tests using 1.0 g/L HSP were completed in lieu of 25 and 758 g/L tests. In addition to these, blanks using de-ionized water at each ionic strength to determine PFAS sources/sinks from sorbent were also tested.

TABLE 8
Experimental matrix for hemp seed powder (HSP)
at high ionic strength (~50 mS/cm) as a function
of solid to liquid (S:L) ration.

| S:L ratio | High ionic Strength MW187s groundwater | | | | | | | | | |
|---|---|---|---|---|---|---|---|---|---|---|
| 0 (control) | 100% | ✓ | 50% | ✓ | 25% | ✓ | 10% | ✓ | 1% | ✓ |
| 1 | 100% | | 50% | | 25% | | 10% | | 1% | |
| 10 | 100% | ✓ | 50% | ✓ | 25% | ✓ | 10% | ✓ | 1% | ✓ |
| 25 | 100% | | 50% | | 25% | | 10% | | 1% | |
| 50 | 100% | ✓ | 50% | ✓ | 25% | ✓ | 10% | ✓ | 1% | ✓ |
| 75 | 100% | | 50% | | 25% | | 10% | | 1% | |
| 100 | 100% | ✓ | 50% | ✓ | 25% | ✓ | 10% | ✓ | 1% | ✓ |
| 200 | 100% | ✓ | 50% | ✓ | 25% | ✓ | 10% | ✓ | 1% | ✓ |

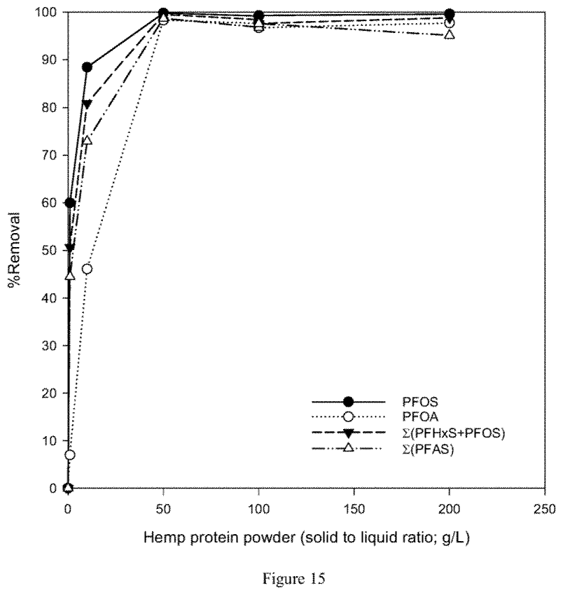

From these experiments, FIG. 15 graphs the removal at low (natural; ˜2 mS/cm) ionic strength of PFOS, PFOA, sum of (PFHxS+PFOS), and sum of PFAS from 100% (undiluted) MW187s as a function of HSP solid to liquid ratio. Under the test conditions, it is evident that ˜50 g/L is sufficient with removals of ˜99.8% PFOS, 98.3% PFOA; 99.5% Σ(PFHxS+PFOS), and 98.7% Σ(PFAS) without TOP analysis (initial concentrations (μg/L) PSO ˜130; PFOA ˜6.82; Σ(PFHxS+PFOS) ˜162; Σ(PFAS) ˜194).

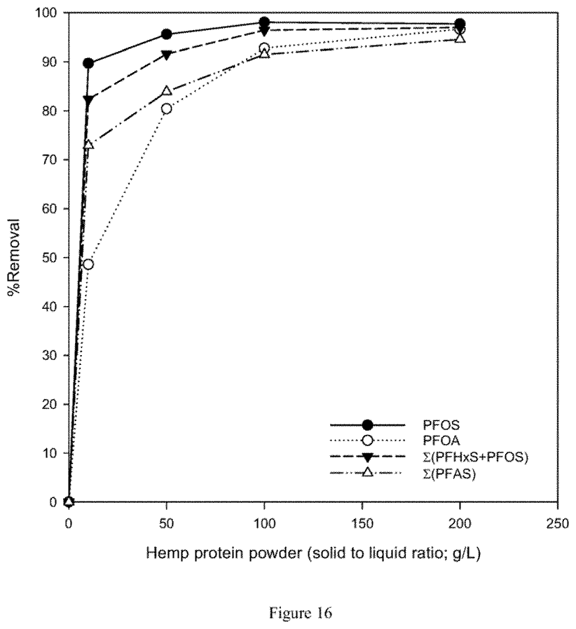

FIG. 16 shows the effect of high ionic strength (approximately sea water salinity; ˜49 mS/cm) on PFAS removal from 100% (undiluted) MW187s (without TOP analysis). Although good removal is experienced at 50 g/L, an increase to 100 g/L does increase PFOA removal by ˜12% and ˜7% for the remaining PFASs (initial concentrations (μg/L) PSO ˜130; PFOA ˜6.82; Σ(PFHxS+PFOS) ˜162; Σ(PFAS) ˜194). This indicates the possibility of a suppression in removal at higher ionic strength.

### Example 5

To refine the HSP mass required for optimal PFAS removal, a series of tests were done in a sequential PFAS removal system. In total, seven batches consisting of a two stage removal (A and B) at various solid to liquid ratios were carried out using 100% (undiluted, low ionic strength) groundwater. For example, Experiment 1 (stage A) consisted of ˜120 mL of undiluted groundwater mixed for 48 hours with 10 g/L HSP. After stage A was completed, the vial was centrifuged and the supernatant and HSP separated. A 60 mL aliquot of the supernatant was transferred to a vial containing HSP at 10 g/L (0.6 g in 60 mL solution) to begin experiment 1 (stage B). The remaining stage A supernatant and used HSP were then refrigerated. Stage B samples were then mixed for a further 48 hours before being centrifuged and separated. All samples were then sent to ALS labs for TOP analysis (liquid and solid) (60 mL was used as this is the volume required by the laboratory for analysis).

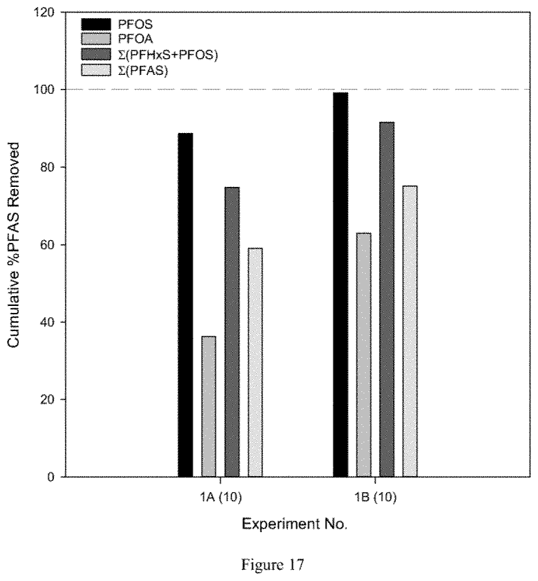

FIG. 17 shows the PFAS removal results for the smallest HSP solid-liquid ratios of 10 g/L for stage A & B removal. It is clear that PFOS has a very high affinity for HSP with 88.7% removed at stage A and >99.1% removal after stage B. PFOA, however only showed a 63% removal after stage B. This is consistent with medical literature which identifies PFOS as being the most tightly bound to human blood proteins.

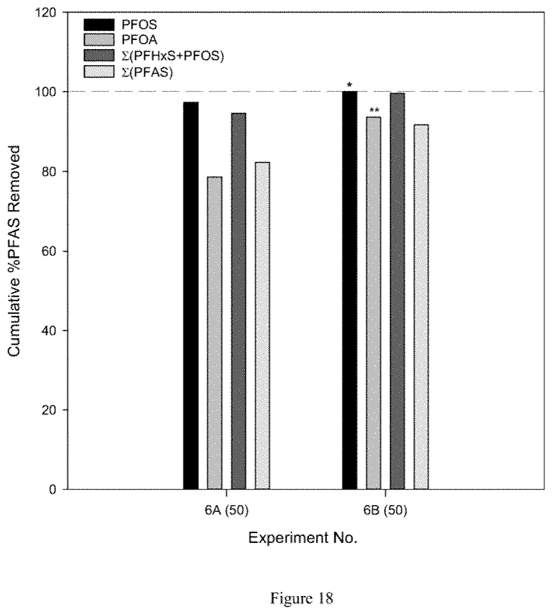

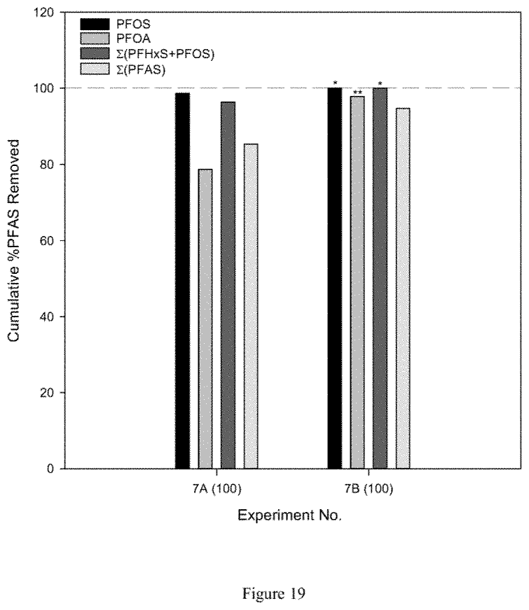

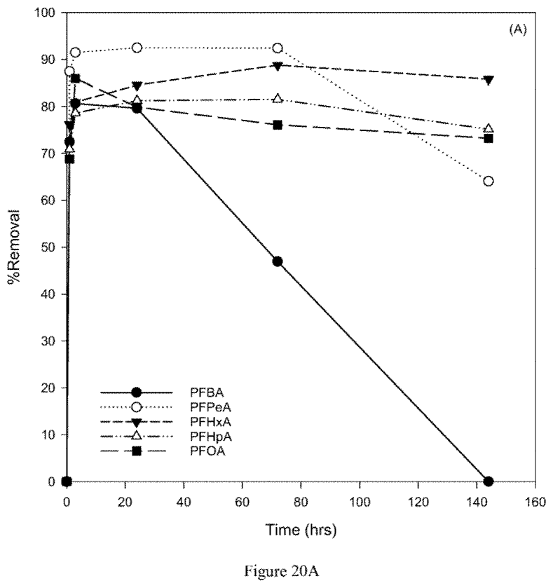

FIG. 18 uses two 50 g/L stages and shows that by the end of stage B, PFOS has been removed to below the laboratory limit of reporting (<0.1 μg/L) (indicated by *). Note this LOR is above the current Australian drinking water guidelines (ADWG) of 0.07 μg/L and further work may be required to enable a more accurate analysis. Additionally, the concentration of PFOA was reduced to >93.7% with a final concentration of 0.53 μg/L which is almost exactly the current ADWG limit of 0.56 μg/L (indicated by **). The sum of PFHxS+PFOS was reduced from 122 to 0.42 μg/L, which is below the recreational concentration limit of 0.7 μg/L.

FIG. 19 represents PFAS removed using two 100 g/L steps with the concentrations of PFOS and Σ(PFHxS+PFOS) reduced to below the laboratory limit of reporting (0.1 μg/L) and PFOA reduced to 0.18 μg/L. Clearly, at stage A, there is little to gain in using HSP at 100 g/L over 50 g/L (FIGS. 18 vs 19). The optimal solid to liquid ratio for PFAS removal may thus be further investigated, for example, a three or four 10 g/L stage treatment system. The number of tests can be reduced by modelling the reactions using data obtained from the reaction kinetics and sorption isotherms.

### Example 6

Tables 8 and 9 outline experiments to determine the kinetics of PFAS removal using HSP and the effect (on kinetics) of adding calcite to the system. During experimentation, aspects of the two tables were combined to produce results that elucidate the kinetics of the reactions as a function of ionic strength and calcite addition to HSP. At this stage, three calcite solid to liquid ratios (1, 10, & 100 g/L) using two different sized calcite fractions (<150 μm & 1.18-2.36 mm) have been tested using either low or high ionic strength or 100% (undiluted) groundwater.

TABLE 8
Experimental matrix for sobent 1 (HSP) & 5 (calcite) at various solid to liquid ratios and ionic strength

| | | High Ionic Strength | | | | | Low Ionic Strength | | | | |
|---|---|---|---|---|---|---|---|---|---|---|---|
| S1:S5 ratio | | Sample C Concentration | | | | | Sample B Concentration | | | | |
| S1x | 1:2 | 100% | 50% | 25% | 10% | 1% | 100% | 50% | 25% | 10% | 1% |
| S1x | 1:1 | 100% | 50% | 25% | 10% | 1% | 100% | 50% | 25% | 10% | 1% |
| S1x | 1:0.25 | 100% | 50% | 25% | 10% | 1% | 100% | 50% | 25% | 10% | 1% |
| S1y | 1:2 | 100% | 50% | 25% | 10% | 1% | 100% | 50% | 25% | 10% | 1% |
| S1y | 1:1 | 100% | 50% | 25% | 10% | 1% | 100% | 50% | 25% | 10% | 1% |
| S1y | 1:0.25 | 100% | 50% | 25% | 10% | 1% | 100% | 50% | 25% | 10% | 1% |

TABLE 9
Experimental matrix for kinetics experiments

| | | Sorbent 1 | | | | Sorbent mix 1&5 | | | |
|---|---|---|---|---|---|---|---|---|---|
| | | High Ionic | | Low Ionic | | High Ionic | | Low Ionic | |
| | | Strength | | Strength | | Strength | | Strength | |
| | | Sample C | | Sample B | | Sample C | | Sample B | |
| TIME | | Concentration | | Concentration | | Concentration | | Concentration | |
| ~5 | min | 100% | 10 or 1% | 100% | 10 or 1% | 100% | 10 or 1% | 100% | 10 or 1% |
| ~15 | min | 100% | 10 or 1% | 100% | 10 or 1% | 100% | 10 or 1% | 100% | 10 or 1% |
| ~30 | min | 100% | 10 or 1% | 100% | 10 or 1% | 100% | 10 or 1% | 100% | 10 or 1% |
| 1 | hr | 100% | 10 or 1% | 100% | 10 or 1% | 100% | 10 or 1% | 100% | 10 or 1% |
| 2 | hr | 100% | 10 or 1% | 100% | 10 or 1% | 100% | 10 or 1% | 100% | 10 or 1% |
| 8 | hr | 100% | 10 or 1% | 100% | 10 or 1% | 100% | 10 or 1% | 100% | 10 or 1% |
| 24 | hr | 100% | 10 or 1% | 100% | 10 or 1% | 100% | 10 or 1% | 100% | 10 or 1% |

Data obtained from the experiments (Tables 8 & 9) were fitted to the selected models namely pseudo-second order kinetics (PSO), intra-particle diffusion (IPD) and Hill models. For simplicity, only the PSO model is described here, although the nature of the other models are well within the common general knowledge of the person skilled in the art.

The Pseudo-second order (PSO) kinetics model (Ho AND McKAY, 1998) is given by:

$$\frac{t}{q \text{?}} \text{?} = \frac{1}{k \text{?} {q}_{e}^{2}} + \frac{t}{{q}_{e}}$$

$$\text{?} \text{indicates text missing or illegible when filed}$$

where qₜ (μg/kg) is the amount of fluoride removal at time t, qₑ (μg/kg) is the sorption capacity at equilibrium, kₚₛₒ, is pseudo-second order rate constant (kg/μg/hr). The PSO instantaneous sorption rate hₚₛₒ (μg/kg/hr) (HO AND McKAY, 1998) is defined by:

hₚₛₒ=kₚₛₒqₑ²

with the reaction half-life (t_{0.5}) or the time for 50% maximum removal to occur is given by:

$${t}_{0.5} = \frac{1}{k \text{?} {q}_{e}}$$

$$\text{?} \text{indicates text missing or illegible when filed}$$

In order to identify the most suitable model to describe the data, the correlation coefficient (R²), AIC (Akaike Information Criterion) and BIC (Schwarz Bayesian Information Criterion) are often used for model selection (TURNER et al., 2014). The R² is efficient in evaluating the goodness-of-fit of each model to the data, however, it is not a good method for comparing the fits between models with differing numbers of parameters. As only one model is presented here, the R² value is presented as a measure of model fitting. The closer the R² value is to 1.00, the better the model fit.

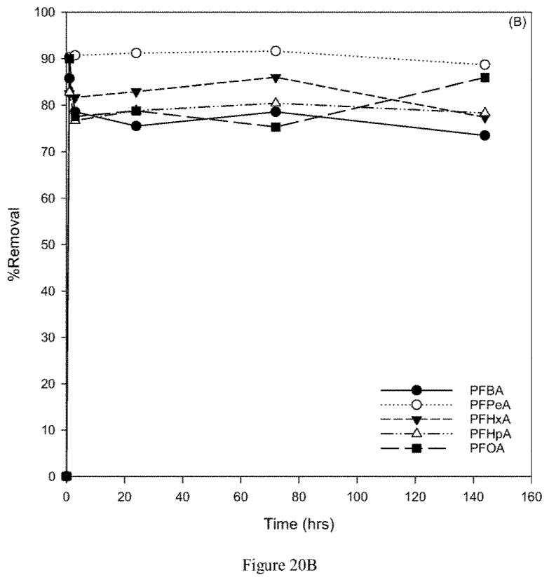

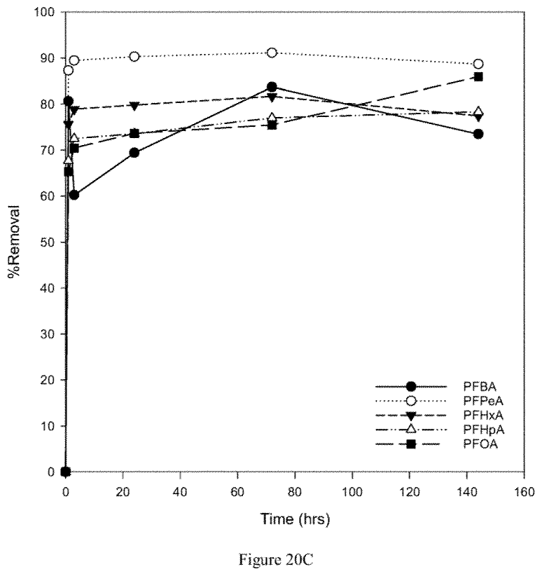

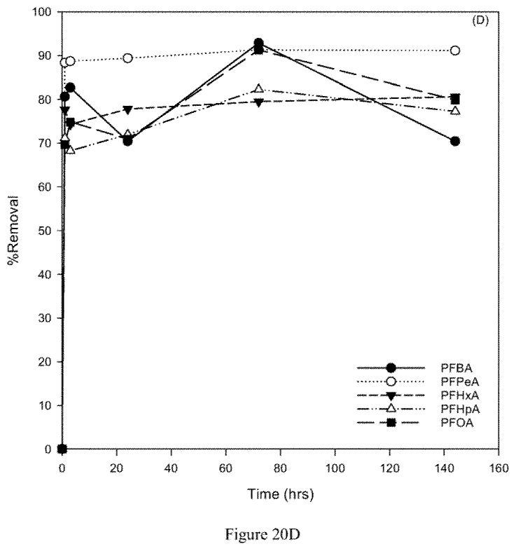

FIGS. 20A to 20D show the percentage removal kinetics of PFCA using HSP from MW187s groundwater and the various treatments (i.e. calcite addition and ionic strength). FIG. 20A shows removal kinetics at low (natural) ionic strength with HSP only; FIG. 20B is for low (natural) ionic strength with HSP and 1.00 g/L calcite (<150 μm); FIG. 20C is for high ionic strength with HSP only; FIG. 20D is for high ionic strength with HSP and 1.00 g/L calcite (<150 μm). All results are from TOP analysis. It can be seen that with HSP alone (FIG. 20A) there is a distinct decrease in removal for PFBA with increasing time. However, other experiments (not shown) also show high variability in PFBA concentrations and it is unknown if this is a general problem, specific for PFBA detection, or simply analysis error due to the small concentrations of PFBA present. Additionally, it is possibly an error introduced via the TOP analysis step where the use of more (or less) of the persulfate oxidant can induce significant changes in the concentrations of short chain PFASs. Consequently, all future results should scrutinise PFBA concentrations closely.

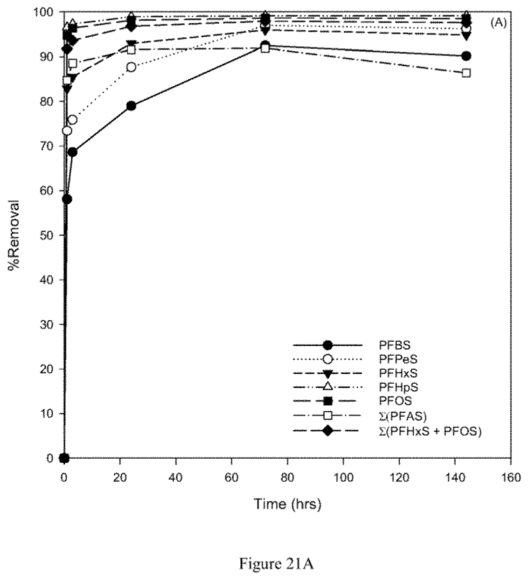

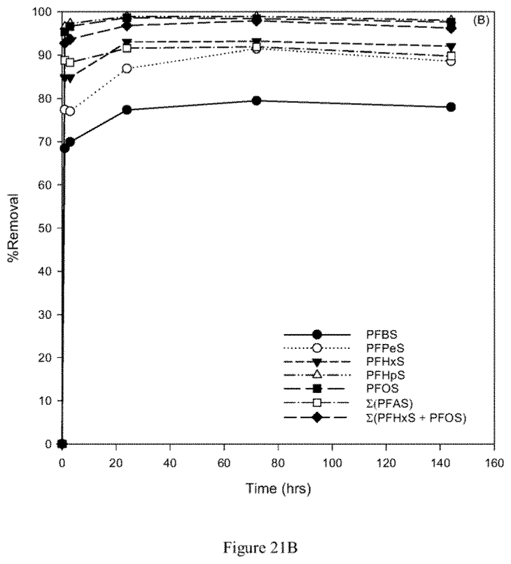

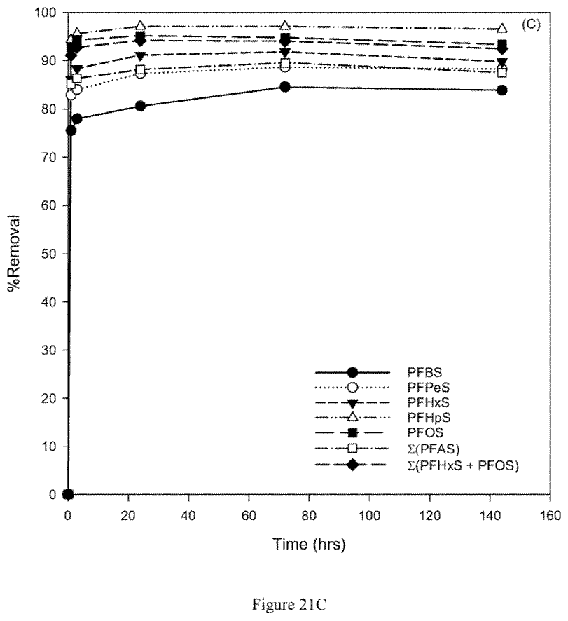

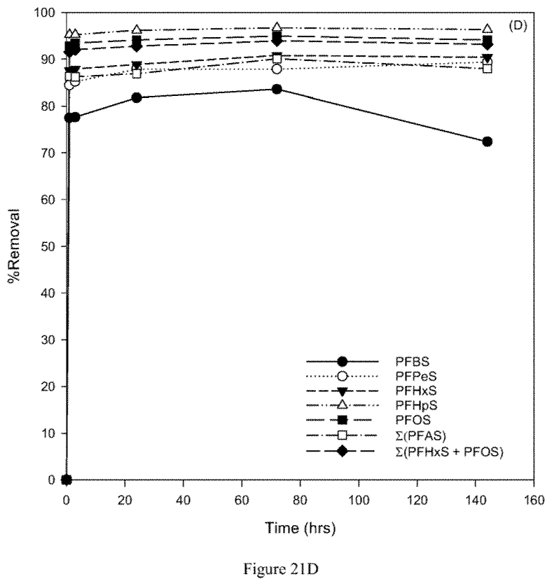

Percentage removal kinetics of PFSAs are analogously shown in FIGS. 21 A-D.

In general, the removal of PFCAs (FIG. 20) and PFSAs (FIG. 21) are rapid (<1 hour) with excellent removals, particularly for the PFSAs, likely due to their higher affinity for the hemp proteins as compared to the PFCAs. The effects of calcite addition and ionic strength are discussed in more detail below in conjunction with the pseudo-second order modelling.

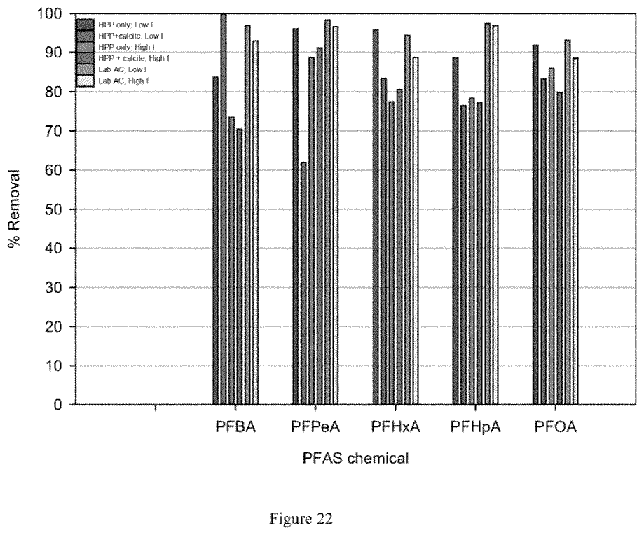

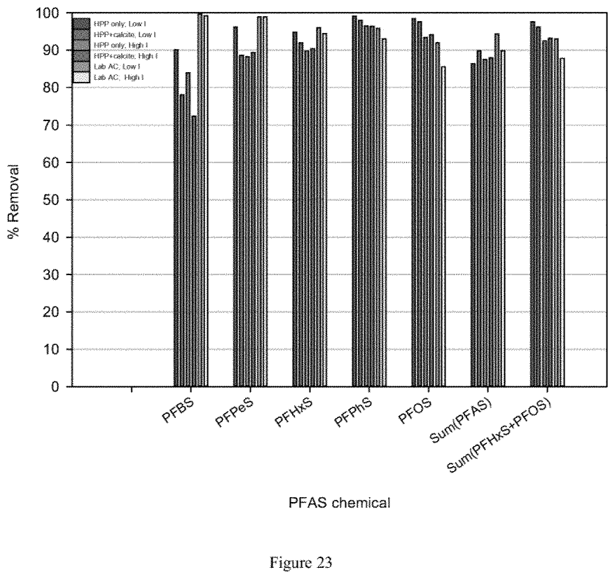

FIGS. 22 and 23 show the percentage removal of PFCAs and PFSAs respectively after six days contact time (144 hours) with HSP alone, and HSP with calcite. These were repeated for low and high ionic strengths at various time steps. For comparison activated carbon (manufactured by Norit® and supplied by Sigma Aldrich) was used at the same solid to liquid ratios at low and high ionic strength. There is no kinetic data for the AC at this time. Note: the AC carbon used here is not the same as those generally used (e.g. Calgan Filtrasorb) for PFAS removal treatment plants.

Results in FIG. 22 & FIG. 23 show that for the same mass of HSP (100 g/L), the addition of 1.0 g/L of calcite powder (<150 μm particle size) increases the removal of short chain PFCAs (FIG. 22). For example, assuming the concentration data is correct for PFBA (4 carbon), its removal increased by ˜17% to below the limit of reporting (<0.1 μg/L) after the addition on calcite. However, the removal of all other PFCAs appears to decrease following calcite addition with PFPeA reduced by ˜32%. The addition of calcite appears to also suppress shorter chain PFSA removal with ˜10-15% decrease in removal observed for PFBS (4 carbon) and PFPeS (5 carbon). No significant changes from the addition of calcite were observed for the remaining PFSAs. However, in light of the discussion concerning PFBA above, laboratory data for all shorter chain PFASs (in particular 4 carbon) generally show high variability, indicating that additional replicates must be done before a definitive conclusion can be reached on the effect of adding calcite to the system.

In addition to the hₚₛₒ model parameter, also obtained from the model were the reaction half-life (t_{0.5}) and equilibrium sorption capacity (qₑ) as described at [000133] and tabulated in the following sections. It should be noted that these parameters are based on the particular reaction conditions described. Under the test conditions it can be seen that the reaction half-lives are very quick being on the order of minutes. In Table 10 to Table 13 the slowest removal of PFOA (high ionic strength, HSP only: Table 12) was 0.22 hours indicating that 13.2 minutes was required to remove 50% of the initial concentration. In comparison, the slowest PFSA was the 4C PFBS (Table 10) requiring 35.4 minutes (t_{0.5}˜4.59 hr) with predicted PFOS half-life rates all less than 2.4 minutes. This is in stark contrast with current technologies such as various activated carbons which appear to take days for equilibration, even at much higher PFAS concentrations than tested here. This is significant as the rate of reaction is generally proportional to the initial concentration of contaminant.

TABLE 10
Kinetic model (PSO) parameters for PFAS removal by HSP
at low (natural) ionic strength, with TOP analysis.

| | hₚₛₒ | kₚₛₒ | qₑ | t_{0.5} | |
|---|---|---|---|---|---|
| PFAS | (μg/kg/hr) | (kg/μg/hr) | (μg/kg) | (h) | R² |
| PFBS | 90.4 | 3.12 × 10⁻² | 53.8 | 0.59 | 0.981 |
| PFPeS | 146.9 | 6.0 × 10⁻² | 49.3 | 0.33 | 0.981 |
| PFHxS | 1582.1 | 2.6 × 10⁻² | 248.7 | 0.16 | 0.996 |
| PFHpS | 1980.8 | 66.9 × 10⁻² | 54.4 | 0.03 | 0.999 |
| PFOS | 1.88 × 10⁴ | 3.23 × 10⁻² | 759.0 | 0.04 | 0.999 |
| Σ(PFAS) | 2.82 × 10⁴ | 9.6 × 10⁻³ | 1717.7 | 0.06 | 0.996 |
| Σ(PFHxS + PFOS) | 1.52 × 10⁴ | 1.4 × 10⁻² | 1010.5 | 0.07 | 0.999 |
| PFBA | NA | NA | NA | NA | 0.337 |
| PFPeA | 2.76 × 10¹⁶ | 2.6 × 10¹² | 102.7 | 3.7 × 10⁻¹⁵ | 0.911 |
| PFHxA | 2265.7 | 2.2 × 10⁻² | 323.9 | 0.14 | 0.998 |
| PFHpA | 267.6 | 0.29 | 30.4 | 0.11 | 0.994 |
| PFOA | 612.7 | 0.22 | 52.3 | 0.08 | 0.972 |

Note:
NA indicates model did not fit.
NA = model did not fit.

TABLE 11
Kinetic model (PSO) parameters for PFAS removal
by HSP with 1.0 g/L calcite (<150 [symbol] m)
at low (natural) ionic strength, with TOP analysis.

| | hₚₛₒ | kₚₛₒ | qₑ | t_{0.5} | |
|---|---|---|---|---|---|
| PFAS | (μg/kg/hr) | (kg/μg/hr) | (μg/kg) | (h) | R² |
| PFBS | 296.1 | 0.13 | 47.7 | 0.16 | 0.995 |
| PFPeS | 266.2 | 0.12 | 46.7 | 0.17 | 0.990 |
| PFHxS | 2357.9 | 3.9 × 10⁻² | 243.3 | 0.10 | 0.996 |
| PFHpS | 2444.2 | 0.83 | 54.2 | 0.02 | 0.999 |
| PFOS | 24859.0 | 4.3 × 10⁻² | 757.6 | 0.03 | 0.999 |
| Σ(PFAS) | 67895.6 | 2.2 × 10⁻² | 1727.8 | 0.03 | 0.999 |
| Σ(PFHxS + PFOS) | 21458.1 | 2.1 × 10⁻² | 1003.8 | 0.05 | 0.999 |
| PFBA | >3 × 10¹⁸ | >1 × 10¹⁷ | 75.3 | <1 × 10⁻¹⁹ | 0.942 |
| PFPeA | 11785.2 | 0.98 | 109.4 | 0.01 | 0.999 |
| PFHxA | 12021.6 | 0.12 | 315.8 | 0.03 | 0.998 |
| PFHpA | >1 × 10²⁰ | >1 × 10¹⁷ | 30.4 | <2 × 10⁻¹⁹ | 0.996 |
| PFOA | >1 × 10¹⁸ | >3 × 10¹⁴ | 52.4 | <5 × 10⁻¹⁷ | 0.963 |

[symbol]

indicates data missing or illegible when filed

TABLE 12
Kinetic model (PSO) parameters for PFAS removal by HSP
at high (~49 mS/cm) ionic strength, with TOP analysis.

| | hₚₛₒ | kₚₛₒ | qₑ | t_{0.5} | |
|---|---|---|---|---|---|
| PFAS | (μg/kg/hr) | (kg/μg/hr) | (μg/kg) | (h) | R² |
| PFBS | 457.8 | 0.18 | 50.6 | 0.11 | 0.997 |
| PFPeS | 672.4 | 0.31 | 46.4 | 0.07 | 0.999 |
| PFHxS | 3973.5 | 0.07 | 239.2 | 0.06 | 0.999 |
| PFHpS | 1773.2 | 0.63 | 53.1 | 0.03 | 0.999 |
| PFOS | 38200.8 | 0.07 | 726.7 | 0.02 | 0.999 |
| Σ(PFAS)⁺ | 41410.1 | 0.01 | 1676.7 | 0.04 | 0.999 |
| Σ(PFHxS + PFOS) | 33671.1 | 0.03 | 968.9 | 0.03 | 0.999 |
| PFBA | >3 × 10¹⁸ | >5 × 10¹⁴ | 72.3 | <10⁻¹⁷ | 0.928 |
| PFPeA | 3207.6 | 0.27 | 107.8 | 0.03 | 0.999 |
| PFHxA | 5501.8 | 0.06 | 298.4 | 0.05 | 0.998 |
| PFHpA | 213.6 | 0.25 | 29.0 | 0.14 | 0.997 |
| PFOA | 230.9 | 0.08 | 51.9 | 0.22 | 0.981 |

TABLE 13
Kinetic model (PSO) parameters for PFAS removal by
HSP with 1.0 g/L calcite (<150 [symbol] m) at high
(~49 mS/cm) ionic strength, with TOP analysis.

| | hₚₛₒ | kₚₛₒ | qₑ | t_{0.5} | |
|---|---|---|---|---|---|
| PFAS | (μg/kg/hr) | (kg/μg/hr) | (μg/kg) | (h) | R² |
| PFBS | 2062.1 | 0.88 | 48.3 | 0.02 | 0.985 |
| PFPeS | 899.7 | 0.41 | 46.6 | 0.05 | 0.999 |
| PFHxS | 7415.9 | 0.13 | 236.5 | 0.03 | 0.999 |
| PFHpS | 3622.6 | 1.30 | 52.7 | 0.01 | 0.999 |
| PFOS | 38968.8 | 0.07 | 725.1 | 0.02 | 0.999 |
| Σ(PFAS) | 61711.6 | 0.02 | 1673.4 | 0.03 | 0.998 |
| Σ(PFHxS + PFOS) | 44322.6 | 0.05 | 964.7 | 0.02 | 0.999 |
| PFBA | >4 × 10²¹ | >6 × 10¹⁷ | 78.2 | <2 × 10⁻²⁰ | 0.936 |
| PFPeA | 3711.1 | 0.32 | 108.1 | 0.03 | 0.999 |
| PFHxA | 9954.6 | 0.12 | 293.7 | 0.03 | 0.996 |
| PFHpA | 273.3 | 0.33 | 28.9 | 0.11 | 0.981 |
| PFOA | 304.1 | 0.11 | 53.6 | 0.18 | 0.961 |

[symbol]

indicates data missing or illegible when filed

Experiments using Norit® activated carbon (AC) under the same conditions (solid-liquid ratio, PFAS concentration, reaction time (6 days) etc) show for PFCAs (FIG. 22) that HSP competes very well with the AC, with PFOA removal at both high and low ionic strength, within 5% of AC. PFPeA appears to have less removal (˜30%) using HSP than AC and further tests would be required to confirm this. The Norit® AC also appears very good for PFSAs (FIG. 23), particularly for the short chain PFBS and PFPeS, which appears to contradict current literature indicating that AC is not suitable for short chain PFASs. For PFOS and PFHxS however, HSP appears to be equal to, or better than, the AC with HSP+calcite showing a removal of within 5% of the Norit® AC.

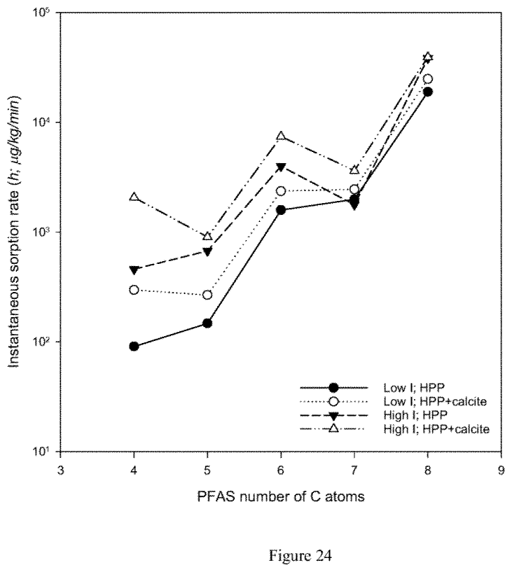

Further comparison of the differences caused by the addition of calcite to HSP can also be derived from the kinetics experiments (Tables 10 to 13). Fitting the pseudo-second order (PSO) model to the data allows the calculation of the instantaneous sorption parameter (hₚₛₒ). The PSO model for instantaneous sorption rate (h) as a function of PFSA carbon chain length (for PFBS (4C), PFPeS (5C), PFHxS (6C), PFHpS (7C), PFOS (8C)) is shown in FIG. 24. For the short chain PFAS, the rate of removal based on hₚₛₒ increases with the addition of calcite (e.g. PFBS Table 10 vs Table 11), and increases with increasing ionic strength (e.g. PFBS Table 10 vs Table 12), and even quicker again at high ionic strength with calcite (e.g. PFBS Table 10 vs Table 13). Overall, the rate of removal increases with chain length indicating that PFOS (8 carbon chain) removal is the fastest (there appears to be no concomitant trend with the PFCAs). As the largest PFAS chemicals sorb the fastest, this indicates the possibility (without wishing to be bound by theory) of different binding positions for each PFAS on the protein. Although all PFASs show very rapid removals, using HSP alone is the slowest with the addition of calcite and salinity increasing the removal rate. Without wishing to be bound by theory, this is possibly attributed to the partial denaturation and the opening up of sorption sites within/on the HSP globular proteins.

### Example 7

To describe the behavior of the adsorption process up to the equilibrium or stabilization point, adsorption isotherms are used. Sorption isotherms were fitted with the Freundlich (equation 1) or Linear model (equation 2):

S=K_{f}C_{eq}^{s} (eqn 1)

S=K_{d}C_{eg} (egn. 2)

where S (μg/kg) is the sorbed concentration, C_{eq} (μg/L) is the concentration remaining in solution, K_{f} and K_{d} ((μg/kg)/(μg/L)) are the Freundlich or linear partitioning constants, and ε (−) is the linearity parameter. The model fitted all isotherms adequately, and there was no need to consider more complex models (potentially bringing a risk of over parametrisation). Note: The partitioning coefficient K_{d}, is a single parameter which, under identical experimental conditions, concisely summarizes the removal ability of a sorbent (protein powders herein).

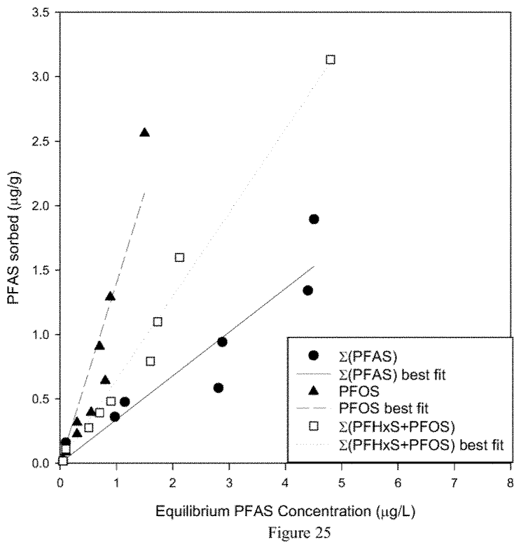

FIG. 25 shows the PFAS removal isotherms for PFOS, Σ(PFAS), and Σ(PFHxS+PFOS). Note: PFOA could not be plotted as all concentrations were below limit of reporting (<0.1 ug/L) which gives an infinite isotherm. The isotherms plotted show a linear fit as the initial concentrations used in the test groundwater are not sufficient to use all possible sorption sites at under the test conditions (100 g/L HSP). Therefore, no prediction as the maximum sorption capacity of HSP can be made from an isotherm as yet, and further testing using concentrations much greater than found in the groundwater are required.

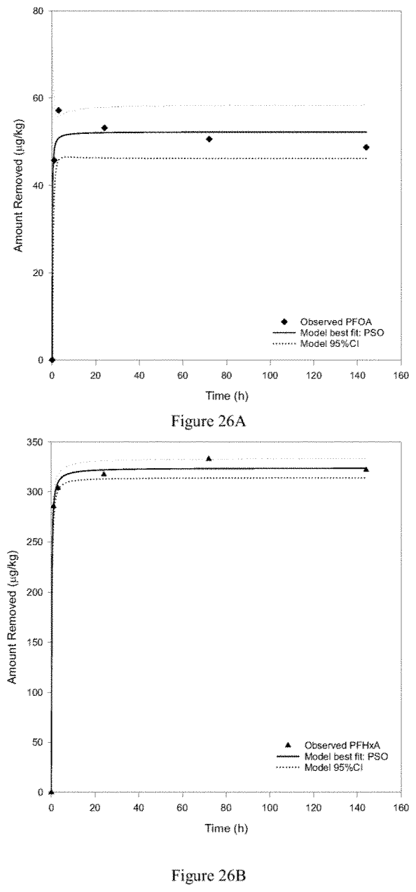

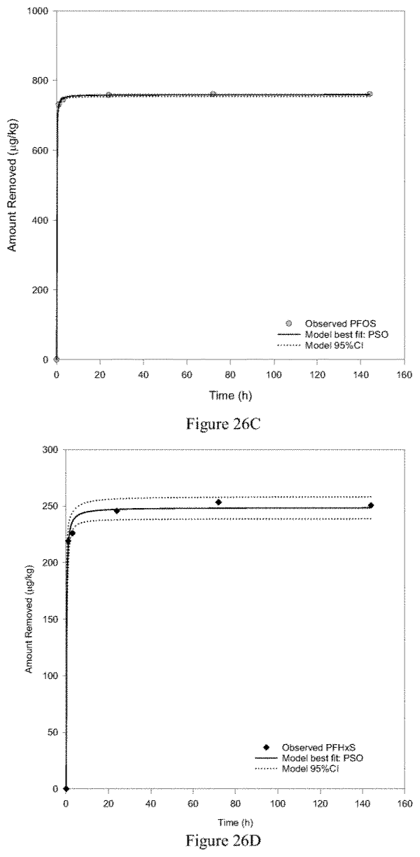

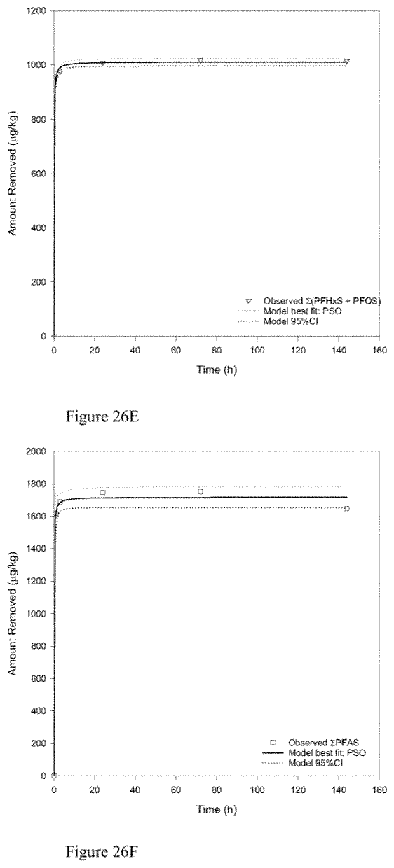

Even though the isotherms (FIG. 25) have not yet achieved maximum removal for any PFAS, the geochemical model used to plot the kinetics reactions can be used to predict the maximum PFAS removal designated as q, (Table 10 to Table 13). In addition to the tabulated data, modelling of the maximum removal in terms of mass of PFAS removed per gram of solid can be seen in FIGS. 26 A-F along with the 95% confidence intervals as derived from the model fitting process. PFOA shows a maximum removal of 60 μg/kg, PFOS ˜750 μg/kg, sum(PFHxS+PFOS) ˜1000 μg/kg, sum(PFAS) ˜1750 μg/kg. It should be noted that the model is predicting these values based on the current concentration limited data range, and it is expected that these will increase with further experiments. Interestingly, a single test using 100 g/L HSP and a spiked sample of water obtained from Moor's Drain, Williamtown (Table 5, Initial[PFOA] ˜766,000 μg/L) showed a removal of 75.2% or 5,743 μg/g, far exceeding the current predicted ˜60 μg/kg (FIG. 26A).

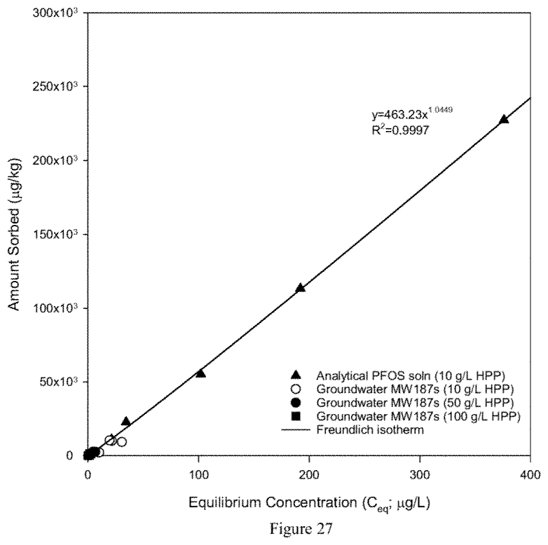

Sorption coefficients (K or Kr) L/kg) were calculated using experiments carried out with analytical grade PFOS solutions and/or experiments using groundwater from monitoring well MW187s at Williamtown RAAF base. The best fit based only on experiments with the analytical PFOS (which also contains PFHxS) solutions (FIG. 27; triangles) was obtained using the Freundlich isotherm. Other data obtained from all groundwater experiments completed thus far have been overlaid and demonstrate the consistency of the results irrespective of the source of the PFAS, or HSP dose rate.

### Example 8

Based on the removal isotherm produced using results from 29 samples including both pure PFHxS+PFOS solutions as well as groundwater, a predictive model was generated in Microsoft Excel for the optimal sequence for PFHxS+PFOS removal using HSP. Using all 29 experiments the best fit Freundlich equation resulted in the K_{f}=405.4 and s=1.0428 (R²˜0.9531). This model predicts the optimal hemp protein powder dose rate required to achieve removal to below the current Australian drinking water guideline of 0.07 μg/L (70 parts per trillion (ppt)).

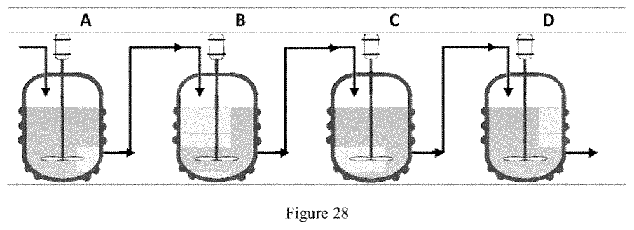

Using a sequential stirred-reactor treatment sequence, the model indicates seven batch reactor steps are required for the treatment of the groundwater sourced “as is” from MW187s. FIG. 28 is a schematic diagram of sequential batch reactors; influent solution enters from the top of the vessel. Effluent solution from the bottom becomes the influent solution for the next batch reactor. Model results for various dosing scenarios are shown in Table 14 to 16. The results show that the optimal dose rate appears to be ˜31 g/L in total over seven batch reactors. By increasing the dose rate slightly to ˜40 g/L total, the number of batch reactors can be decreased to five (Table 15), and if 75 g/L total dosing is used, only 3 steps is required to achieve the drinking water target (Table 16).

TABLE 14
Hemp protein powder dose rate and modeled (predicted)
influent and effluent PFHxS + PFOS concentration
for each sequential batch reactor. Total HSP 31 g/L

| | Hemp Protein | Influent | Effluent |
|---|---|---|---|
| Batch | Powder | concentration | concentration |
| Reactor | dose (g/L) | (μg/L) | (μg/L) |
| A | 5 | 122 | 33.90 |
| B | 5 | 33.9 | 9.81 |
| C | 5 | 9.81 | 2.94 |
| D | 5 | 2.94 | 0.916 |
| E | 5 | 0.916 | 0.295 |
| F | 4 | 0.295 | 0.098 |
| G | 2 | 0.098 | 0.034 |
| Cumulative | 31 | | |
| HSP mass | | | |
| (g/L) | | | |

TABLE 15
Hemp protein powder dose rate and modeled (predicted)
influent and effluent PFHxS + PFOS concentration
for each sequential batch reactor. Total HSP 40 g/L

| | Hemp Protein | Influent | Effluent |
|---|---|---|---|
| Batch | Powder | concentration | concentration |
| Reactor | dose (g/L) | (μg/L) | (μg/L) |
| A | 10 | 122 | 19.70 |
| B | 10 | 19.70 | 3.39 |
| C | 10 | 3.39 | 0.622 |
| D | 5 | 0.622 | 0.202 |
| E | 5 | 0.202 | 0.068 |
| F | — | — | — |
| G | — | — | — |
| Cumulative | 40 | | |
| HSP mass | | | |
| (g/L) | | | |

TABLE 16
Hemp protein powder dose rate and modeled (predicted)
influent and effluent PFHxS + PFOS concentration
for each sequential batch reactor. Total HSP 75 g/L

| | Hemp Protein | Influent | Effluent |
|---|---|---|---|
| Batch | Powder | concentration | concentration |
| Reactor | dose (g/L) | (μg/L) | (μg/L) |
| A | 25 | 122 | 8.72 |
| B | 25 | 8.72 | 0.692 |
| C | 25 | 0.692 | 0.061 |
| D | — | — | — |
| E | — | — | — |
| F | — | — | — |
| G | — | — | — |
| Cumulative | 75 | | |
| HSP mass | | | |
| (g/L) | | | |

### Example 9

Thermal destruction of sorbent and bound PFAS was assessed as follows.

Fourier transform infrared (FTIR) spectroscopy is a non-destructive technique that allows a biochemical fingerprint of a sample to be taken. It is routinely applied in the areas of biology, chemistry, and medicine to characterize complex biochemical systems from cells and subcellular compartments to whole organisms.

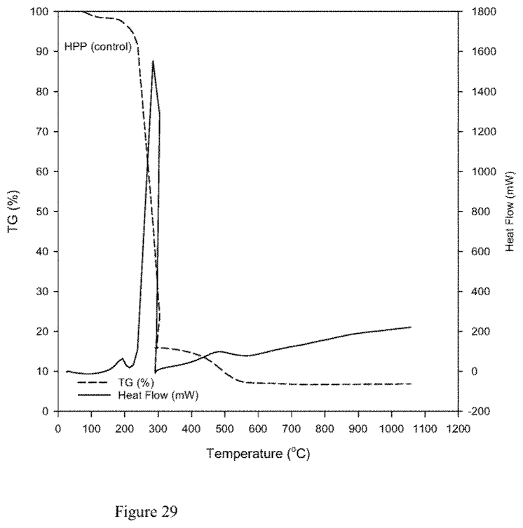

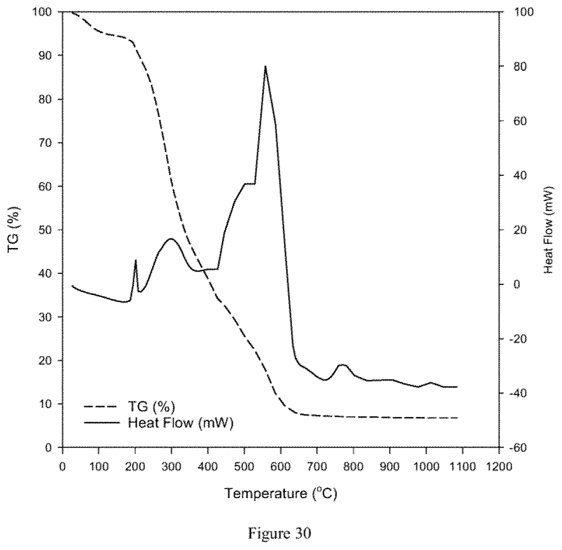

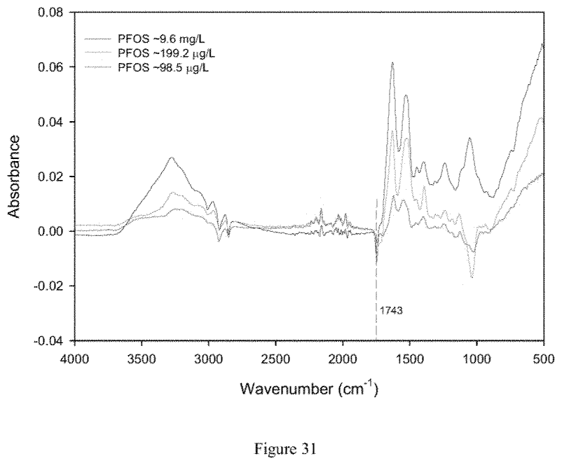

FIG. 29 and FIG. 30 show the thermogravimetric (TG) and heat flow curves during combustion of HSP exposed to de-ionised water only (FIG. 29) and HSP exposed to PFOS at an initial concentration of ˜9.6 mg/L (FIG. 30). In both curves, the mass losses by 700° C. are within 2% at ˜92% with the remaining 8% identified by FTIR (see below) as amorphous silica (glass/sand). When exposed to PFOS, the heat required to destroy the HSP increases from ˜550° C. to ˜650° C. with the exothermic (positive) heat flow maxima shifting from ˜300° C. to ˜550° C. Without wishing to be bound by theory, this is potentially because of the higher temperatures required for the destruction of C—F bonds in the PFOS. The shift to higher temperatures for HSP destruction after exposure to PFOS is consistent with the addition (via sorption) of chemical ligands (PFOS) to the HSP proteins. This is supported by the FTIR data (FIG. 31) which shows the infra-red difference spectra of HSP samples exposed to three different concentrations of PFOS.

The idea behind difference spectra is to see the changes of a specific group against the absorption background of several other absorbing groups in the same spectral region. Infrared difference spectra are the result of subtracting a spectrum of the protein in state A from a spectrum of the protein in state B. In this way, only groups that actively participate in the reaction are evident, whereas the absorbance of groups that do not participate in the reaction are cancelled in the subtraction. There are several causes for a change in absorbance. For example, the reactants become transformed into reaction products that absorb in different regions of the spectrum, resulting in negative and positive bands; or the frequency might be shifted due to changes in the environment of the vibrating bond, resulting in a negative band and a positive band in close proximity (KUMAR, 2014).

In all cases in FIG. 31, the spectra have been corrected by subtracting the control sample (HSP exposed to DI water only) thus leaving only the difference spectra (i.e. the peaks that have been affected by PFOS sorption). FIG. 31 clearly shows a number of peaks (˜3200, 2900, and 1750-900 cm⁻¹) that increase with increasing PFOS concentration. Three peaks can be seen to show a negative absorbance (˜3000, 1743 and 1050 cm⁻¹) with the peak at 1743 cm⁻¹ representative of a band associated with carbonyl (C═O) stretching vibration (SERVICE et al., 2010). This band is characteristic of amino acids, and the fact that it appears increasingly negative with increasing PFOS concentration, indicates the association of PFOS molecules with this particular site on the protein. The spectra and subsequent interpretation is very complicated and further work on these is required before any definitive conclusions can be made as to the PFAS/HSP interactions. It is clear, however, that there is a definitive association occurring.

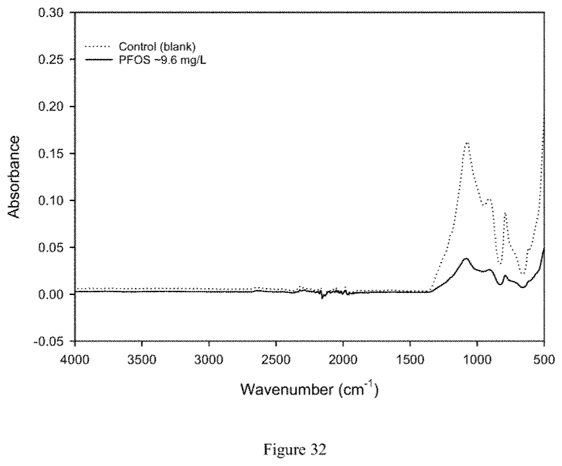

FIG. 32 shows the FTIR spectra of the HSP control and HSP exposed to PFOS after thermal destruction. It can be seen that there are remaining large peaks at ˜1070-1100 cm⁻¹, characteristic of the Si—O stretching vibration, and consequently the FTIR spectral databases used here indicate that the final material after thermal destruction is an amorphous silica product. This indicates that all PFAS has been destroyed during the pyrolysis, however this would need to be confirmed with XRD/XRF and or X-ray Photoelectron spectroscopy analysis.

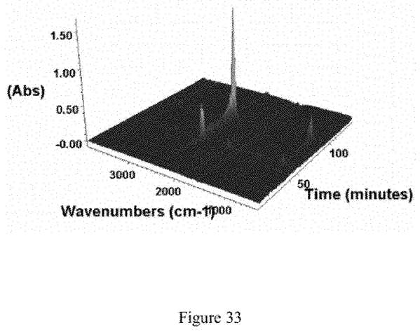

TGA-DSC and evolved gas FTIR techniques may additionally be used to elucidate the potential sorption mechanisms of the reactions. For example, FIG. 33 shows the evolved gas analysis during the thermal destruction (at 10° C./min) under an oxygen atmosphere for hemp protein powder (FIG. 33). The region below 2000 cm⁻¹ wavenumbers is distinctly different for the PFOA exposed sample, and shows the presence of carboxylic acid functional groups as well as carbon-fluorine groups below 500° C. (<50 min). Large peaks at ˜2400 cm⁻¹ are due to evolved CO₂ associated with plant material pyrolysis. No adverse gas products have been identified.

The FTIR spectra of biological systems are very complex, since they often consist of overlapping absorption bands from the main components. Therefore, to extract the significant (non-redundant) information in the spectra, it is necessary to apply various multivariate analysis techniques. This is even more crucial when time dependent data, such as that obtained in evolved gas analysis, is used. The data obtained from hemp protein powder exposed to various PFAS solutions is complex, however when coupled with the analysis of the evolved gases during thermal destruction, the amount of information which requires processing is immense.

### Example 10

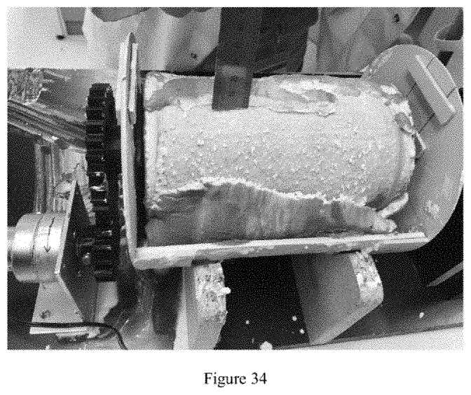

A laboratory bench scale PFAS treatment system has been designed based on the results from PFAS removal experiments outlined. A small scale rotary drum vacuum (RDV; FIG. 34) was applied to the treated waste stream and served two functions:

(i) to remove the used/spent HSP material. The vacuum component of the system also serves to dry the spent HSP, eliminating the need for large areas of land normally required for dewatering prior to thermal destruction; and
(ii) to “polish” and clarify the treated water, removing any residual solids from the remediation stages.

The RDV in its current form has been tested using HSP in de-ionized water at a solid-to-solution ratio of 100 g/L. The procedure uses a solution of diatomaceous earth (DE) to create a filtration cake on the drum prior to removing the HSP waste. The DE effectively becomes a highly permeable layer which traps the HSP on the surface, but allows the treated water to pass through into the drum. The polished (decontaminated and visually clean) water is then removed via the vacuum.

The treatment stages for PFAS removal using HSP (prior to the RDV step) could include any number of methods, including existing batch reactor vessels such as those available from Coates hire. Theoretically, any of the current in-line filtration treatment plants may be able to be utilized simply by swapping existing sorbents with the correct HSP dosing. However, in-line filtration experiments would need to be trialed first to determine bed-volume treatment life, pressure changes etc.

Also of benefit is the utilisation potential of the technology to current stockpiles of concentrated PFAS waste, a residual of the GAC/reverse osmosis PFAS treatment plants. As salinity does not appear to adversely impact PFAS removal by HSP, its application to these waste-streams may be a viable option for this growing problem in PFAS remediation.

Given the rapid kinetics of the reaction, it is proposed that large “tea bag” type hemp filters be constructed and placed via a crane into Lake Cochran, Williamtown, one of the most PFAS contaminated areas at the RAAF base. Once saturated, these could be lifted out to free drain, and the contents analysed, de-watered and thermally destroyed.

### Example 11

PFAS Removal using other plant proteins was measured. The aim was to determine the effectiveness of other plant proteins on the removal of PFAS compounds from groundwater sourced from MW187s at Williamtown. As each plant protein has a different total amount (%) of proteins the laboratory data must be normalised to compare final removal figures. Table 17 shows the amino acid and total protein percentage of each plant protein powder used. Note: these values are taken from the information given by the manufacturer. Actual protein and amino acid content will be determined by the National Measurement Institute (NMI) Laboratories, Melbourne.

Plant proteins used to treat PFAS contamination.
Protein content (%) and amino acids content.

| | | | | Egg | | |
|---|---|---|---|---|---|---|
| | Hemp | | Pea | white | Whey | |
| | protein | | Protein | powder | protein | Lupin |
| | powder | Soy | Isolate | (albumin) | isolate | Flour |
| Protein % | 49.9 | 90.5 | 80.0 | 79.0 | 91.4 | 38.5 |

Amino Acids (mg per 100 g sample)

| | | | | | | |
|---|---|---|---|---|---|---|
| Isoleucine | 1,730 | 4,300 | 2,500 | 4,340 | 6,300 | 4,400 |
| Leucine | 2,840 | 7,800 | 4,800 | 6,820 | 14,300 | 7,500 |
| Lysine | 1,540 | 6,500 | 8,300 | 6,500 | 11,200 | 4,700 |
| Methionine | 760 | 1,400 | 7,300 | 3,020 | 2,400 | 700 |
| Phenylalanine | 1,980 | 5,400 | 1,000 | 4,730 | 3,800 | 3,700 |
| Threonine | 1,430 | 3,600 | 5,100 | 3,640 | 5,300 | 3,400 |
| Tryptophan | 480 | 1,000 | 5,000 | 1,320 | 2,400 | 800 |
| Valine | 2,060 | 4,500 | 3,800 | 5,580 | 5,600 | 3,500 |
| Histidine | 1,180 | 2,700 | — | 1,890 | 2,000 | 2,700 |
| Alanine | 1,600 | 4,200 | 4,200 | 4,960 | 5,700 | — |
| Arginine | 5,430 | 8,000 | 8,700 | 4,650 | 3,000 | — |
| Aspartic acid | 4,130 | 12,100 | 11,500 | 8,220 | 12,500 | — |
| Cysteine cystine | 700 | 1,400 | 1,100 | 2,170 | 4,000 | 1,800 |
| Glutamic acid | 7,360 | 20,400 | 17,200 | 10,540 | 17,600 | — |
| Glycine | 1,160 | 4,200 | 4,200 | 2,790 | 1,800 | — |
| Praline | 1,640 | 5,300 | 5,300 | 3,100 | 4,500 | — |
| Serine | 2,050 | 5,700 | 4,500 | 5,500 | 4,500 | — |
| Tyrosine | 1,290 | 4,100 | 4,000 | 3,180 | 4,200 | 3,400 |

Note:
these values are taken from the information given by the manufactuere. Actual protein and amino acid content will be determined by the National Measurement Institute (NMI) Laboratories, Melbourne.

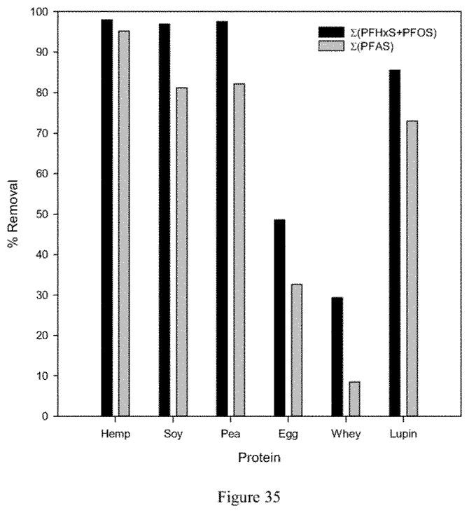

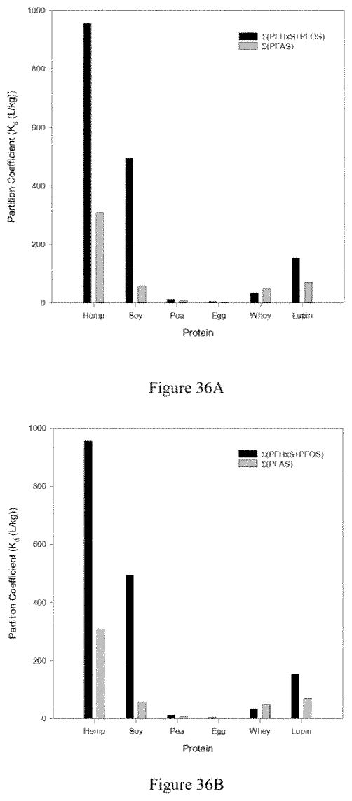

FIG. 35 shows the % PFAS removal for each protein powder prior to normalization. As can be seen, soy and pea protein powders appear to compare favourably to Hemp for removal of PFHxS+PFOS. However, as demonstrated above, using the K_{d} value is an excellent way to compare at a glance the removal efficiencies of each plant protein. FIG. 36 shows the K values for each plant protein which have been normalized for total protein content (for ease of viewing both the linear (FIG. 36A) and logarithmic (FIG. 36B) plots are displayed).

It is clear that after normalisation for protein content, hemp powder is superior for the removal of both PFHxS+PFOS as well as total sum PFAS with the overall removal order being Hemp>Soy>Lupin>Whcy>Pea>Egg.

1. An adsorbent for perfluoroalkyl and polyfluoroalkyl substances, wherein the adsorbent comprises one or more proteins.

2. The adsorbent according to claim 2, wherein the one or more proteins are plant proteins.

3. An adsorbent according to claim 1, wherein the one or more proteins include albumins.

4. An absorbent according to claim 1, wherein the one or more proteins include globulins.

5. The adsorbent according to claim 1, wherein the one or more proteins include edestin.

6. The adsorbent according to claim 1, wherein the one or more proteins include glycinin.

7. The adsorbent according to claim 1, wherein the one or more proteins include beta-conglycinin.

8. The adsorbent according to claim 1, wherein the one or more proteins are structurally similar to albumins and/or globulins and/or edestin and/or glycinin and/or beta-conglycinin.

9. The adsorbent according to claim 1, wherein the one or more proteins are derived from hemp seeds.

10. The adsorbent according to claim 9, wherein the adsorbent comprises hemp seeds.

11. The adsorbent according to claim 9, wherein the adsorbent comprises hemp protein isolate.

12. The adsorbent according to claim 1, wherein the adsorbent comprises soy protein.

13. The adsorbent according to claim 1, wherein the adsorbent further comprises calcite.

14. The adsorbent according to claim 1, wherein the adsorbent further comprises an inert substance configured to increase the permability of the adsorbent.

15. The adsorbent according to claim 14, wherein the inert substance is glass beads.

16. The adsorbent according to claim 14, wherein the inert substance is gravel.

17. Use of an adsorbent according to claim 1 for treatment of a material contaminated with perfluoroalkyl and polyfluoroalkyl substances.

18. The use according to claim 17, wherein the material is groundwater.

19. The use according to claim 17, wherein the material is residual water from soil washing.

20. A process for the treatment of ground water contaminated with perfluoroalkyl and polyfluoroalkyl substances, wherein the contaminated ground water is pumped to the surface and directed to an adsorption step comprising the adsorbent according to claim 1.

21. A process for the treatment of ground water contaminated with perfluoroalkyl and polyfluoroalkyl substances, wherein a permeable reactive barrier comprising the adsorbent according to claim 1 is located in the path of an aquifer contaminated with perfluoroalkyl and polyfluoroalkyl substances.

22. A process for the treatment of spent adsorbent according to claim 1, comprising thermal destruction of spent adsorbent.

23. The process according to claim 22, wherein thermal destructions occurs at a temperature selected from <700° C., <650° C., <600° C., <550° C., <500° C. or <450° C.

24. The process according to claim 21, wherein the spent adsorbent is dewatered and dried prior to thermal destruction.

25. The process according to claim 21, wherein gasses evolved by thermal destruction are scrubbed with an alkaline solution, wherein the alkaline solution is subsequently reacted with calcite to form fluorite.
